(19) United States
(12) Patent Application Publication
(10) Pub. No.: US 2025/0356063 A1
(43) Pub. Date: Nov. 20, 2025

(54) ELECTRONIC DEVICE INCLUDING A STORAGE DEVICE AND A HOST DEVICE AND METHODS OF OPERATION

(71) Applicant: SK hynix Inc., Icheon-si (KR)

(72) Inventor: Taek Gyu LEE, Icheon-si (KR)

(21) Appl. No.: 18/964,369

(22) Filed: Nov. 30, 2024

(30) Foreign Application Priority Data
May 14, 2024 (KR) 10-2024-0063283

(51) Int. Cl. G06F 21/79; G06F 21/60; G06F 21/64

(52) U.S. Cl. CPC G06F 21/79; G06F 21/602; G06F 21/64

(57) ABSTRACT

A storage device for providing a security function may include: a nonvolatile memory device including a Replay Protected Memory Block (RPMB); and a memory controller configured for receiving, from an external host, a command UFS Protocol Information Unit (UPIU) including a host RPMB message, and storing data in the RPMB according to authentication performed using the host RPMB message. The command UPIU may include a basic header segment commonly included in UPIUs transmitted/received between the external host and the memory controller, and the basic header segment may include a data segment length field as information indicating that the host RPMB message has been included in the command UPIU.

### CROSS-REFERENCE TO RELATED APPLICATION

The present application claims priority under 35 U.S.C. § 119 (a) to Korean patent application number 10-2024-0063283 filed on May 14, 2024, in the Korean Intellectual Property Office, the entire disclosure of which is incorporated by reference herein.

### BACKGROUND

### 1. Technical Field

The present disclosure generally relates to an electronic device, and more particularly, to a storage device, a host device, an electronic device that includes a storage device and a host device, and methods of operation.

### 2. Related Art

A storage device is a device that stores data under the control of a host device such as a computer or a smartphone. The storage device may include a memory device that stores data and a memory controller that controls the memory device. A memory device can be a memory device or a nonvolatile memory device.

A volatile memory device is a memory device in which data is stored only when power is supplied, and the stored data disappears when the supply of power is interrupted. A volatile memory device may include a Static Random Access Memory (SRAM), a Dynamic Random Access Memory (DRAM), and the like.

A nonvolatile memory device is a memory device in which data does not disappear even when the supply of power is interrupted. A nonvolatile memory device may include a Read Only Memory (ROM), a Programmable ROM (PROM), an Electrically Programmable ROM (EPROM), an Electrically Erasable ROM (EEROM), a flash memory, and the like.

### SUMMARY

Embodiments provide a storage device, a host device, an electronic device including a storage device and a host device, and methods of operation that can provide a security function having an improved speed.

In accordance with an aspect of the present disclosure, there is provided a storage device including: a nonvolatile memory device including a Replay Protected Memory Block (RPMB); and a memory controller configured to receive, from an external host, a command UFS Protocol Information Unit (UPIU) including a host RPMB message, and store data in the RPMB according to an authentication performed using the host RPMB message, wherein the command UPIU includes a basic header segment that is included in a UPIU exchanged between the external host and the memory controller, and wherein the basic header segment includes a data segment length field as information indicating that the host RPMB message has been included in the command UPIU.

In accordance with another aspect of the present disclosure, there is provided a storage device including: a nonvolatile memory device including a Replay Protected Memory Block (RPMB); and a memory controller configured to receive, from an external host, a command UFS Protocol Information Unit (UPIU) including a host RPMB message, and to read data stored in the RPMB, wherein the command UPIU includes a basic header segment included in UPIUs exchanged between the external host and the memory controller, and wherein the basic header segment includes a data segment length field with information indicating that the host RPMB message has been included in the command UPIU.

### BRIEF DESCRIPTION OF THE DRAWINGS

Example embodiments will now be described more fully hereinafter with reference to the accompanying drawings; however, the inventions may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a storage device in accordance with an embodiment of the present disclosure.

FIG. 2 is a diagram illustrating a memory device shown in FIG. 1 in accordance with an embodiment of the present disclosure.

FIG. 3 is a diagram illustrating a structure of any memory block from among memory blocks shown in FIG. 2 in accordance with an embodiment of the present disclosure.

FIG. 4 is a diagram illustrating a data communication unit between a Replay Protected Memory Block (RPMB) host controller and an RPMB device controller in accordance with an embodiment of the present disclosure.

FIG. 5 is a diagram illustrating a structure of a basic header segment of a Universal Flash Storage (UFS) Protocol Information Unit (UPIU) in accordance with an embodiment of the present disclosure.

FIG. 6 is a diagram illustrating RPMB message components constituting an RPMB message in accordance with an embodiment of the present disclosure.

FIG. 7 is a diagram illustrating an RPMB message data frame constituting an RPMB message in accordance with an embodiment of the present disclosure.

FIG. 8 is a diagram illustrating a storage device in accordance with an embodiment of the present disclosure.

FIG. 9 is a flowchart illustrating an authenticated data write operation performed in a normal RPMB mode in accordance with an embodiment of the present disclosure.

FIG. 10 is a diagram illustrating an RPMB message provided through step S805 shown in FIG. 9 in accordance with an embodiment of the present disclosure.

FIG. 11 is a diagram illustrating an RPMB message provided through step S813 shown in FIG. 9 in accordance with an embodiment of the present disclosure.

FIG. 12 is a diagram illustrating an RPMB message provided through step S819 shown in FIG. 9 in accordance with an embodiment of the present disclosure.

FIG. 13 is a flowchart illustrating an authenticated data read operation performed in a normal RPMB mode in accordance with an embodiment of the present disclosure.

FIG. 14 is a diagram illustrating an RPMB message provided through step S1005 shown in FIG. 13 in accordance with an embodiment of the present disclosure.

FIG. 15 is a diagram illustrating an RPMB message provided through step S1011 shown in FIG. 13 in accordance with an embodiment of the present disclosure.

FIG. 16 is a diagram illustrating a configuration of a command UPIU in accordance with an embodiment of the present disclosure.

FIG. 17 is a diagram illustrating a configuration of a response UPIU in accordance with an embodiment of the present disclosure.

FIG. 18 is a flowchart illustrating an authenticated data write operation performed in a high speed RPMB mode in accordance with an embodiment of the present disclosure.

FIG. 19 is a flowchart illustrating an authenticated data read operation performed in a high speed RPMB mode in accordance with an embodiment of the present disclosure.

FIG. 20 is a diagram illustrating a UPIU transmitter included in an initiator device in accordance with an embodiment of the present disclosure.

FIG. 21 is a diagram illustrating a UPIU receiver included in a target device in accordance with an embodiment of the present disclosure.

FIG. 22 is a diagram illustrating an embodiment of a memory controller shown in FIG. 1 in accordance with an embodiment of the present disclosure.

FIG. 23 is a block diagram illustrating a memory card system to which a storage device in accordance with an embodiment of the present disclosure is applied.

FIG. 24 is a block diagram illustrating a Solid State Drive (SSD) system to which a storage device in accordance with an embodiment of the present disclosure is applied.

FIG. 25 is a block diagram illustrating a user system to which a storage device in accordance with an embodiment of the present disclosure is applied.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

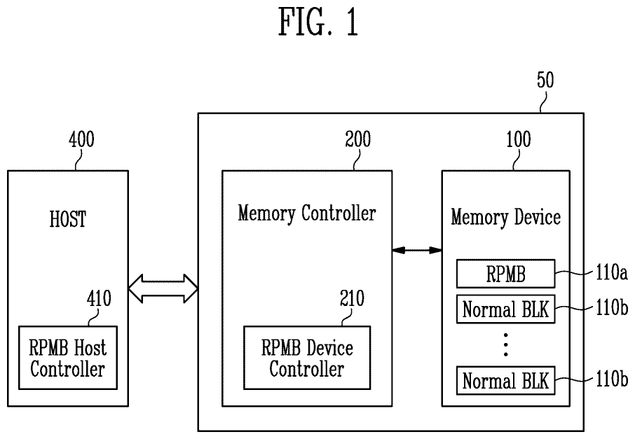

FIG. 1 is a diagram illustrating a storage device in accordance with an embodiment of the present disclosure in accordance with an embodiment of the present disclosure.

Referring to FIG. 1, a storage device 50 may include a memory device 100 and a memory controller 200. The storage device 50 may be a device for storing data under the control of a host 400, such as a mobile phone, a smartphone, an MP3 player, a laptop computer, a server computer, a desktop computer, a game console, a TV, a tablet PC or an in-vehicle infotainment. Alternatively, the storage device 50 may be a device for storing data under the control of a host 400 for storing high-capacity data in one place, such as a server or a data center.

The storage device 50 may be manufactured as any one of various kinds of storage devices according to a host interface and a communication scheme with the host 400. For example, the storage device 50 may be configured as any one of a variety of types of storage devices, such as a Solid State Drive (SSD), a multimedia card in the form of an MMC, an eMMC, an RS-MMC or a micro-MMC, a secure digital card in the form of an SD, a mini-SD or a micro-SD, a Universal Serial Bus (USB) memory module, a Universal Flash Storage (UFS) device, a personal computer memory card international association (PCMCIA) card type memory module, a peripheral component interconnection (PCI) card type memory module, a PCI express (PCI-E) card type memory module, a Compact Flash (CF) card, a Smart Media Card (SMC), and a memory stick.

The storage device 50 may be manufactured as any one of various kinds of package types. For example, the storage device 50 may be manufactured as any one of various kinds of package types such as a Package-On-Package (POP), a System-In-Package (SIP), a System-On-Chip (SOC), a Multi-Chip Package (MCP), a Chip-On-Board (COB), a Wafer-level Fabricated Package (WFP), and a Wafer-level Stack Package (WSP).

A memory device 100 may store data. The memory device 100 may operate under the control of the memory controller 200. The memory device 100 may include a memory cell array (not shown) including a plurality of memory cells for storing data.

Each of the memory cells may be configured as a Single Level Cell (SLC) storing one-bit data, a Multi-Level Cell (MLC) storing two-bit data, a Triple Level Cell (TLC) storing three-bit data, or a Quad Level Cell (QLC) storing four-bit data.

The memory cell array (not show) may include a plurality of memory blocks. Each memory block may include a plurality of memory cells. Each memory block may include a plurality of pages. In an embodiment, a page may be a unit for storing data in the memory device 100 or reading data stored in the memory device 100. A memory block may be a unit for erasing data.

The memory blocks included in the memory device 100 may include a Replay Protected Memory Block (RPMB) 110a and a normal block (Normal BLK) 110b.

The RPMB 110a may be a memory block accessed through a predetermined specific command or authentication. The Normal BLK 110b may be a memory block accessed without separate authentication. The Normal BLK 110b may be a memory block that stores data, except for data stored in the RPMB 110a.

When the storage device 50 supports an RPMB 110a, the RPMB 110a may be accessed according to at least two modes. For example, the RPMB 110a may be accessed in any one of a normal RPMB mode and an advanced RPMB. In accordance with embodiments of the present disclosure, an RPMB 110a may be accessed in a high speed RPMB mode.

A write count value indicating a number of times data is successfully stored in the RPMB 110a may be limited to a certain number of times or less. Therefore, when the write count value for the RPMB 110a reaches a maximum write count value, only a read operation on the RPMB 110a may be allowed.

A write unit in which data is stored and a unit in which data is read may be predetermined for memory blocks. For example, when a RPMB 110a is accessed in a normal RPMB mode or a high speed RPMB mode, data may be stored or read in a unit size of 256 bytes. When a RPMB 110a is accessed in an advanced RPMB mode, data may be stored or read in a unit size of 4 Kbytes. However, the unit of data size accessed in the advanced RPMB mode is not limited to 4 Kbytes, and may vary according to a data unit of a program operation performed by the memory device 100.

Access to the RPMB 110a may be allowed only when authentication succeeds. Authentication for the RPMB 110a may be an operation of determining whether Message Authentication Codes (MACs), generated by the host 400 and the storage device 50 respectively using pre-arranged data and the same authentication key, are the same (or match). The host 400 and the storage device 50 store the authentication key initially only once. A MAC may be generated by each of the host 400 and the storage device 50, using a hash-based message authentication code (HMAC SHA-256), but methods of generating the MAC are not limited thereto. While an authentication key and a write count value of the RPMB 110a are maintained, data stored in the RPMB 110a may be maintained.

In FIG. 1, the memory device 100 includes one RPMB 110a. However, the memory device 100 may include two or more RPMBs 110a. Each RPMB 110a may have a unique authentication key and a unique write count value.

In an embodiment, one RPMB 110a may be partitioned into a plurality of RPMB regions. The maximum number of RPMB regions included in an RPMB 110a may be four. Each RPMB region may include a unique authentication key and a unique write count value.

The RPMB regions included in the RPMB 110a may be defined according to an RPMB descriptor. The RPMB descriptor may be provided by a command that the host 400 provides to the storage device 50 or a command that the storage device 50 provides to the host 400. The RPMB descriptor may include an RPMB region enable value bRPMBRegionEnable of 8 bits, which is used to set the RPMB regions included in the RPMB 110a.

In an embodiment, the storage device 50 supports access to the RPMB 110a through the normal RPMB mode, the advanced RPMB mode, and the high speed RPMB mode, and the mode may be determined using the RPMB region enable value bRPMBRegionEnable.

In an embodiment, the RPMB region enable value bRPMBRegionEnable may be set according to rules described in the following Table 1.

TABLE 1

| Bits | Rules |
|---|---|
| BIT-0 | RPMB region 0 is always enabled independent of this bit |
| | value. |
| BIT-1 | Set to 1 to enable RPMB region 1. |
| BIT-2 | Set to 1 to enable RPMB region 2. |
| BIT-3 | Set to 1 to enable RPMB region 3. |
| BIT-4 | Set to 1 to enable Advanced RPMB Mode. (Set to 0 to |
| | enable Normal RPMB Mode.) |
| BIT-5 | Set to 1 to enable High Speed RPMB Mode. (Set to 0 to |
| | enable Normal RPMB Mode.) |
| BIT-6~7 | Reserved. |

In an embodiment, an access mode of the RPMB 110a may be set as the normal RPMB mode, the advanced RPMB mode, or the high speed RPMB mode according to the RPMB region enable value bRPMBRegionEnable. The storage device 50 may process, as failure, an access request for the RPMB 110a from the host 400 when the request of the host 400 is different from the set RPMB mode.

In an embodiment, the memory device 100 may be a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), a NAND flash memory, a vertical NAND flash memory, a NOR flash memory, a Resistive Random Access Memory (RRAM), a Phase-Change Random Access Memory (PRAM), a Magnetoresistive Random Access Memory (MRAM), a Ferroelectric Random Access Memory (FRAM), a Spin Transfer Torque Random Access Memory (STT-RAM), or the like. In this specification, for convenience of description, described examples assume that the memory device 100 is a NAND flash memory.

The memory device 100 may receive a command and an address from the memory controller 200, and access an area selected by the address in the memory cell array. The memory device 100 may perform an operation indicated by the command on the area selected by the address. For example, the memory device 100 may perform a write operation (program operation), a read operation, and an erase operation. In the program operation, the memory device 100 may program data in the area selected by the address. In the read operation, the memory device 100 may read data from the area selected by the address. In the erase operation, the memory device 100 may erase data stored in the area selected by the address.

The memory controller 200 may control overall operations of the storage device 50.

When power is applied to the storage device 50, the memory controller 200 may execute firmware (FW). Although not illustrated, when the memory device 100 is a flash memory device, the memory controller 200 may execute firmware such as a Flash Translation Layer (FTL) for controlling communication between the host 400 and the memory device 100.

In an embodiment, the memory controller 200 may receive data and a Logical Block Address (LBA) from the host 400, and translate the LBA into a Physical Block Address (PBA) indicating an address of memory cells included in the memory device 100, in which data is stored.

The memory controller 200 may control the memory device 100 to perform a write operation, a read operation, an erase operation, or the like in response to a request from the host 400. In a program operation, the memory controller 200 may provide a program command, a PBA, and data to the memory device 100. In a read operation, the memory controller 200 may provide a read command and a PBA to the memory device 100. In an erase operation, the memory controller 200 may provide an erase command and a PBA to the memory device 100.

In an embodiment, the memory controller 200 may autonomously generate a command, an address, and data regardless of any request from the host 400, and transmit the command, the address, and the data to the memory device 100. For example, the memory controller 200 may provide the memory device 100 with a command, an address, and data, which are used to perform program, read and erase operations accompanied in performing wear leveling, read reclaim, garbage collection, and the like.

In an embodiment, the memory controller 200 may control at least two memory devices 100. The memory controller 200 may control the memory devices according to an interleaving scheme so as to improve operational performance. The interleaving scheme may be a scheme for controlling operations to overlap with each other on at least two memory devices 100.

The host 400 may communicate with the storage device 50, using at least one of various communication manners, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a Non-Volatile Memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

In this specification, for convenience of description, the storage device 50 and the host 400 are described as performing data communication according to a UFS communication interface. However, embodiments of the present disclosure are not limited data communication according to a UFS communication interface.

For example, the storage device 50 and the host 400 may perform data communication using a command defined as a UFS Protocol Information Unit (hereinafter, referred to as a UPIU). The UPIU may be a kind of data packet generated according to a predetermined protocol.

The UPIU may be a command for allowing the host 400 or the storage device 50 to request, instruct, or respond to performance of a certain operation. In an embodiment, various UPIUs may be defined according to uses and purposes. For example, the UPIU may be any one of a Query Request UPIU, a Command UPIU, a Response UPIU, a Data Out UPIU, a Data In UPIU, and a Ready To Transfer UPIU.

In an embodiment, the Query Request UPIU may include a device descriptor providing several parameters of the storage device 50. The device descriptor may include information indicating whether the storage device 50 is a storage device that supports a high speed RPMB mode or an advanced RPMB mode.

The smallest size of the UPIU may be 32 bytes, and a maximum size of the UPIU may be 65600 bytes. The format of the UPIU may have different sizes according to the type of UPIU.

The memory controller 200 may include an RPMB device controller 210.

The RPMB device controller 210 may process an access request for the RPMB 110a from the host 400.

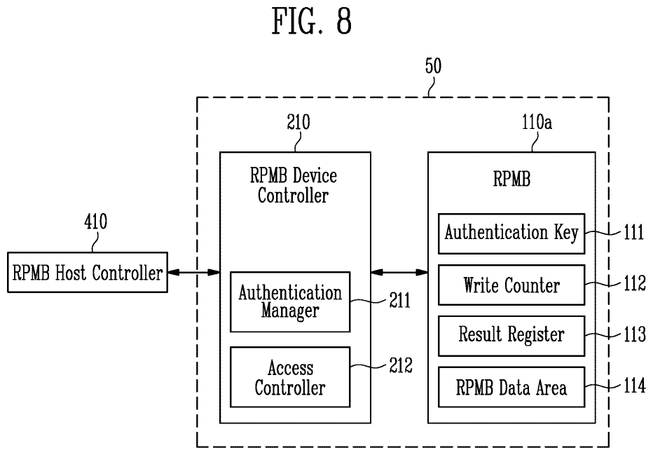

The RPMB device controller 210 may process an authenticated data write operation of storing data in the RPMB 110a and an authenticated data read operation of reading data stored in the RPMB 110a. A method of processing, by the RPMB device controller 210, an authenticated data write operation and an authenticated data read operation will be described later in detail with reference to FIGS. 8 to 21.

The host 400 may further include an RPMB host controller 410.

The RPMB host controller 410 may generate UPIUs for controlling the RPMB 110a, and provide the generated UPIUs to the RPMB device controller 210. The RPMB host controller 410 may receive UPIUs transmitted by the RPMB device controller 210.

The RPMB device controller 210 and the RPMB host controller 410 will be described in detail later with reference to FIGS. 8, 20, and 21.

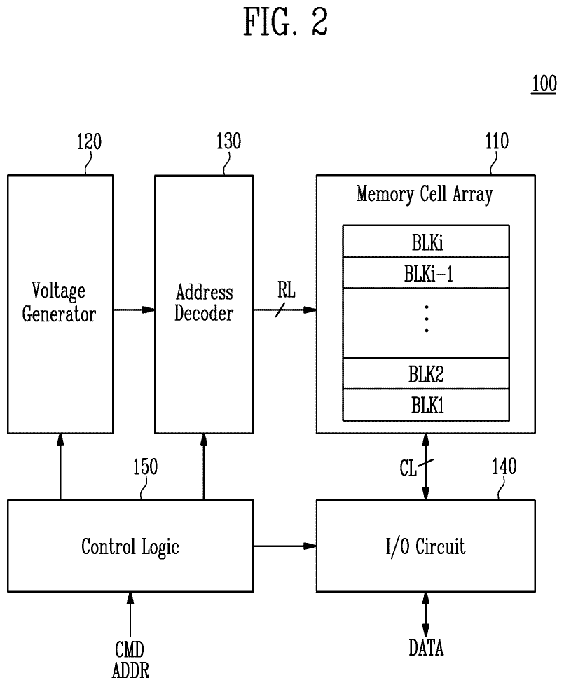

FIG. 2 is a diagram illustrating a memory device shown in FIG. 1 in accordance with an embodiment of the present disclosure.

Referring to FIG. 2, a memory device 100 may include a memory cell array 110, a voltage generator 120, an address decoder 130, an input/output (I/O) circuit 140, and a control logic 150.

The memory cell array 110 may include a plurality of memory blocks BLK1 to BLKi. The plurality of memory blocks BLK1 to BLKi may be connected to the address decoder 130 through row lines RL. The plurality of memory blocks BLK1 to BLKi may be connected to the I/O circuit 140 through column lines CL. In an embodiment, the row lines RL may include word lines, source select lines, and drain select lines. In an embodiment, the column lines may include bit lines.

Each of the plurality of memory blocks BLK1 to BLKi includes a plurality of memory cells. In an embodiment, the plurality of memory cells may be nonvolatile memory cells. Among the plurality of memory cells, memory cells connected to the same word line may be defined as one physical page. That is, the memory cell array 110 may include a plurality of physical pages. Each of the memory cells of the memory device 100 may be configured as a Single Level Cell (SLC) storing one data bit, a Multi-Level Cell (MLC) storing two data bits, a Triple Level Cell (TLC) storing three data bits, or a Quadruple Level Cell (QLC) storing four data bits.

Some of the plurality of memory blocks BLK1 to BLKi may correspond to RPMBs 110a described above with reference to FIG. 1, and some of the other memory blocks BLK1 to BLKi may correspond to normal blocks 110b described above with reference to FIG. 1.

In an embodiment, the voltage generator 120, the address decoder 130, and the I/O circuit 140 may be commonly designated as a peripheral circuit. The peripheral circuit may drive the memory cell array 110 under the control of the control logic 150. The peripheral circuit may driver the memory cell array 110 to perform a program operation, a read operation, and an erase operation.

The voltage generator 120 may generate a plurality of operating voltages by using an external power voltage supplied to the memory device 100. The voltage generator 120 may be operated under the control of the control logic 150.

In an embodiment, the voltage generator 120 may generate an internal power voltage by regulating the external power voltage. The internal power voltage generated by the voltage generator 120 may be used as an operating voltage of the memory device 100.

In an embodiment, the voltage generator 120 may generate a plurality of operating voltages by using the external power voltage or the internal power voltage. The voltage generator 120 may generate various voltages required in the memory device 100. For example, the voltage generator 120 may generate a plurality of erase voltages, a plurality of program voltages, a plurality of pass voltages, a plurality of select read voltages, and a plurality of unselect read voltages.

In order to generate a plurality of operating voltages having various voltage levels, the voltage generator 120 may include a plurality of pumping capacitors that receive internal power voltage. The voltage generator 120 may generate a plurality of operating voltages by selectively enabling the plurality of pumping capacitors under the control of the control logic 150.

The plurality of operating voltages generated by the voltage generator 120 may be supplied to the memory cell array 110 by the address decoder 130.

The address decoder 130 may be connected to the memory cell array 110 through the row lines RL. The address decoder 130 may be operated under the control of the control logic 150. The address decoder 130 may receive an address ADDR from the control logic 150. The address decoder 130 may decode a block address in the received address ADDR. The address decoder 130 may select at least one memory block among the plurality of memory blocks BLK1 to BLKi according to the decoded block address. The address decoder 130 may decode a row address in the received address ADDR. The address decoder 130 may select at least one word line among word lines of the selected memory block according to the decoded row address. In an embodiment, the address decoder 130 may decode a column address in the received address ADDR. The I/O circuit 140 and the memory cell array 110 may be connected to each other according to the decoded column address.

In an example, the address decoder 130 may include components such as a row decoder, a column decoder, and an address decoder.

The I/O circuit 140 may include a plurality of page buffers. The plurality of page buffers may be connected to the memory cell array 110 through bit lines. In a program operation, data may be stored in selected memory cells according to data stored in the plurality of page buffers.

In a read operation, the data stored in the selected memory cells may be sensed through the bit lines, and the sensed data may be stored in the page buffers.

The control logic 150 may control the address decoder 130, the voltage generator 120, and the I/O circuit 140. The control logic 150 may be operated in response to a command CMD transferred from an external device. The control logic 150 may control the peripheral circuit by generating control signals in response to the command CMD and the address ADDR.

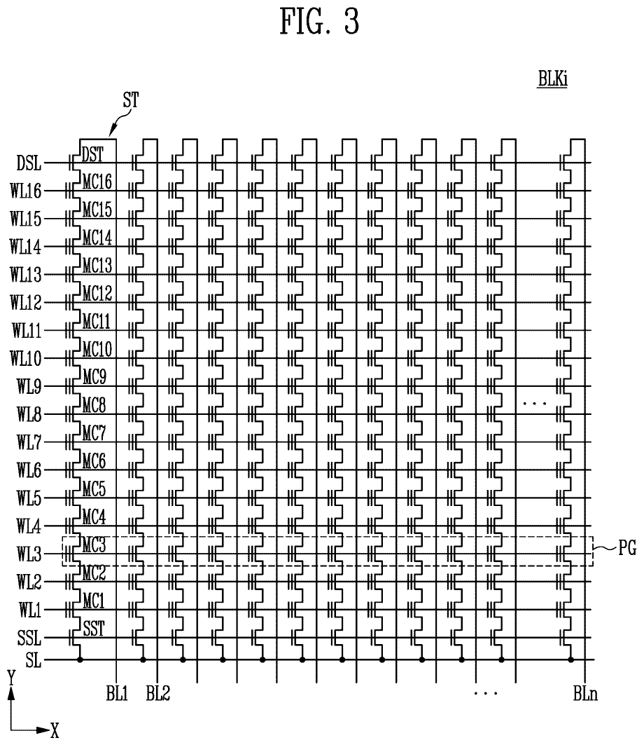

FIG. 3 is a diagram illustrating a structure of any memory block from among memory blocks shown in FIG. 2 in accordance with an embodiment of the present disclosure.

For example, FIG. 3 illustrates any one memory block BLKi from among memory blocks BLK1 to BLKi shown in FIG. 2.

Referring to FIG. 3, a plurality of word lines arranged in parallel to each other may be connected between a first select line and a second select line. The first select line may be a source select line SSL, and the second select line may be a drain select line DSL. More specifically, the memory block BLKi may include a plurality of strings ST connected between bit lines BL1 to BLn and a source line SL. The bit lines BL1 to BLn may be respectively connected to the strings ST, and the source line SL may be commonly connected to the strings ST. The strings ST may be configured identically to one another, and therefore, a string ST connected to a first bit line BL1 will be described in detail as an example.

The string ST may include a source select transistor SST, a plurality of memory cells MC1 to MC16, and a drain select transistor DST, which are connected in series to each other between a source line SL and a first bit line BL1. At least one source select transistor SST and at least one drain select transistor DST may be included in one string ST. While FIG. 3 illustrates sixteen memory cells MC1 to MC16, the number of memory cells are not limited and in other embodiments, more cells than shown in FIG. 3 may be included in one string ST.

A source of the source select transistor SST may be connected to the source line SL, and a drain of the drain select transistor DST may be connected to the first bit line BL1. The memory cells MC1 to MC16 may be connected in series between the source select transistor SST and the drain select transistor DST. Gates of source select transistors SST included in different strings ST may be connected to the source select line SSL, and gates of drain select transistors DST included in different strings ST may be connected to the drain select line DSL. Gates of the memory cells MC1 to MC16 may be connected to a plurality of word lines WL1 to WL16. A group of memory cells connected to the same word line but included in different strings ST may be referred to as a physical page PG. Therefore, physical pages PG corresponding to the number of the word lines WL1 to WL16 may be included in the memory block BLKi.

One memory cell may store data of one bit. This memory cell is generally called a single level cell (SLC). One physical page PG may store one logical page (LPG) data. One logical page (LPG) data may include data bits corresponding to the number of cells included in one physical page PG.

One memory cell may store data of two or more bits. One physical page PG may store two or more logical page (LPG) data.

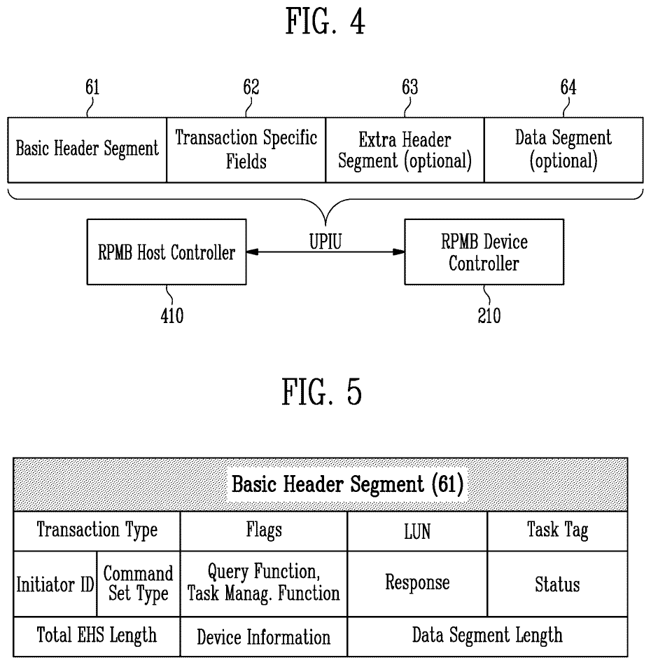

FIG. 4 is a diagram illustrating a data communication unit between a Replay Protected Memory Block (RPMB) host controller and an RPMB device controller in accordance with an embodiment of the present disclosure.

Referring to FIGS. 1 and 4, an RPMB host controller 410 and an RPMB device controller 210 may communicate with each other using data packets that are UFS Protocol Information Units (hereinafter, referred to as UPIUs). In terms of physical devices, the RPMB host controller 410 is included in a host 400, and the RPMB device controller 210 is included in a storage device 50. In terms of communication between the two devices, any one device may transmit a UPIU to the other device to exchange UPIUs. A device generating a UPIU may be referred to as an initiator device, and a device receiving the generated UPIU may be referred to as a target device. That is, a UPIU is not a data packet that any one of the host 400 and the storage device 50 unilaterally transmit to the other device, but may be a data packet transmitted between the two devices.

Types of UPIU may include a Query Request UPIU, a Command UPIU, a Response UPIU, a Data Out UPIU, a Data In UPIU, and a Ready To Transfer UPIU according to the operation to be performed by the RPMB host controller 410 or the RPMB device controller 210.

The Query Request UPIU may include a device descriptor providing several parameters of the storage device 50. The device descriptor may include information indicating whether the storage device 50 is a storage device that supports an advanced RPMB mode. In an embodiment, the Query Request UPIU may include an RPMB descriptor.

The RPMB host controller 410 may provide the RPMB device controller 210 with the Query Request UPIU including the RPMB descriptor. The RPMB descriptor may include an RPMB region enable value bRPMBRegionEnable of 8 bits, which sets RPMB regions included in the RPMB 110a. In an embodiment, the storage device 50 supports access to the RPMB 110a in a mode such as a normal RPMB mode, an advanced RPMB mode, and a high speed RPMB mode, and the mode may be determined using the RPMB region enable value bRPMBRegionEnable.

The Command UPIU may be a UPIU transmitted when the host 400 transfers a command to the storage device 50.

The Response UPIU may be a UPIU transmitted when the storage device 50 provides a response to a command provided by the host 400.

The Data Out UPIU may be a UPIU transmitted when the host 400 provides data to the storage device 50.

The Data In UPIU may be a UPIU transmitted when the storage device 50 provides data to the host 400.

The Ready To Transfer UPIU may be a UPIU transmitted when the storage device 50 indicates that the storage device 50 is ready to receive a Data Out UPIU from the host 400. The Ready To Transfer UPIU may be transmitted when the storage device 50 has sufficient buffer space to store data provided by the host 400.

The smallest size of the UPIU may be 32 bytes, and a maximum size of the UPIU may be 65,600 bytes. The format of the UPIU may have different sizes according to the UPIU type.

In an embodiment, the UPIU may include a basic header segment 61, transaction specific fields 62, an extra header segment 63, and a data segment 64.

The basic header segment 61 may have a size of 12 bytes. The basic header segment 61 may be included in common in all UPIUs. The basic header segment 61 may include basic setting information related to the UPIU.

The transaction specific fields 62 may be included in byte addresses from byte address 12 to byte address 31 of the UPIU. The transaction specific field 62 may include a dedicated transaction code according to the type of the UPIU.

The extra header segment 63 is optional and may be defined when a total extra header segment length (Total EHS Length) field of the basic header segment 61 has a value that is not 0. The extra header segment 63 may start from byte address 32 of the UPIU. The extra header segment 63 may be a region capable of storing additional data when sufficient information is not included in the basic header segment 61.

The data segment 64 is optional and may be included in the Data Out UPIU or the Data In UPIU in the normal RPMB mode or the advanced RPMB mode, and may not be included in the other UPIUs. In other embodiments, the data segment 64 may be included in all UPIUs in a high speed RPMB mode.

FIG. 5 is a diagram illustrating a structure of a basic header segment of a Universal Flash Storage (UFS) Protocol Information Unit (UPIU) in accordance with an embodiment of the present disclosure.

Referring to FIG. 5, a basic header segment 61 may include Transaction Type, Flags, Logical Unit Number (LUN), Task Tag, Initiator ID, Command Set Type, Query Function/Task Management Function, Response, Status, Total Extra Header Segment (EHS) Length, Device Information, and Data Segment Length.

The Transaction Type may be a field having a unique value according to UPIU type. An example of the Transaction Type according to UPIU type is shown in the following Table 2.

TABLE 2

| When initiator | | | |
|---|---|---|---|
| device provides | | When target device | |
| UPIU to target | Transaction | provides UPIU to | Transaction |
| device | Type | initiator device | Type |
| Command UPIU | 00 0001b | Response UPIU | 10 0001b |
| Data Out UPIU | 00 0010b | Data In UPIU | 10 0010b |
| X | X | Ready To Transfer | 11 0001b |
| | | UPIU | |

The Flags may be a field having different values according to the Transaction Type.

The Logical Unit Number (LUN) may be a field indicating a number of a logical unit on which an operation is to be performed, from among a plurality of logical units included in a target device on which the operation is performed. For example, each of the host 400 and the storage device 50, which are described above with reference to FIG. 1, may include a plurality of logical units, and the Logical Unit Number (LUN) of the basic header segment 61 included in the UPIU may indicate a specific logical unit from among the plurality of logical units.

The Task Tag may be a field having different values according to the Transaction Type.

The Initiator ID may be a field for identifying the initiator requesting an operation. Therefore, the Initiator ID may have a value when the host 400 generates the UPIU that is different from when the storage device 50 generates the UPIU.

The Command Set Type may be a field included in the Command UPIU and the Response UPIU. The Command Set Type may be a field indicating in which interface a command is supported. For example, the Command Set Type may be a field indicating whether a Command Set Type command is an SCSI command, a UFS command, or a command defined by a manufacturer.

The Query Function/Task Management Function may be a field input to a UPIU such as a query request, a query response, or a task management request.

The Response may be a field indicating whether the performance of a requested operation has succeeded or failed.

The Status may be a field indicating an SCSI status.

The Total EHS Length may be a field indicating a size of an extra header segment in a 32-bit unit. The Total EHS Length may be used when the UPIU includes the extra header segment. The length of the extra header segment may be a 4-byte unit. The maximum size of the extra header segment may be 1024 bytes. When the extra header segment is not used, the Total EHS Length may be 0.

The Device Information may include information used only when a specific function is performed.

The Data Segment Length may be a field indicating a length of a data segment of the UPIU. When the UPIU does not include a data segment, the Data Segment Length may be 0.

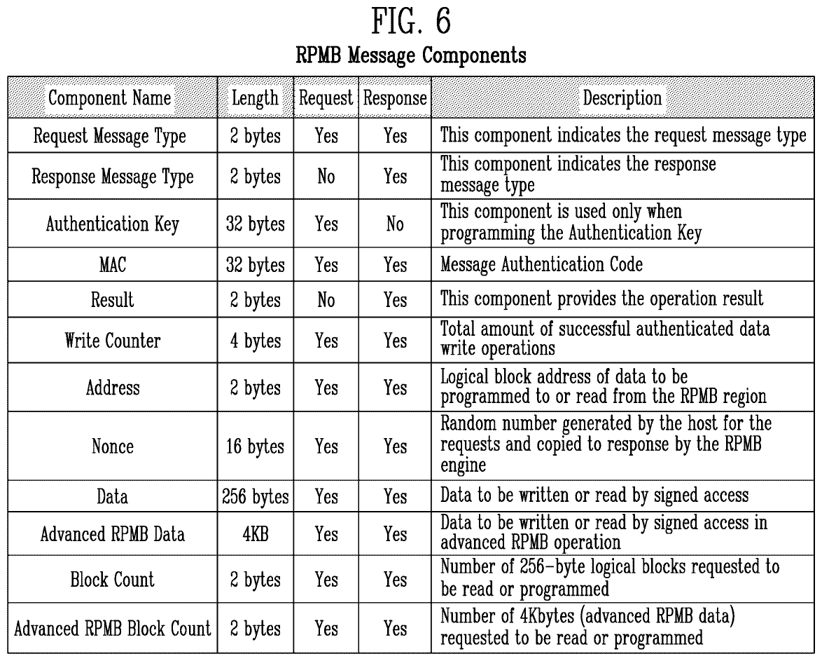

FIG. 6 is a diagram illustrating RPMB message components constituting an RPMB message in accordance with an embodiment of the present disclosure.

Referring to FIGS. 1 and 6, when a host 400 or a storage device 50 transmits/receives a UPIU related to a RPMB 110a, one of the host 400 or the storage device 50, as an initiator, may transfer an RPMB message to the other. The RPMB message may include information for authentication.

The RPMB message may include a plurality of components. The RPMB message may include some or all of the plurality of components shown in FIG. 6 according to the nature of the transferred RPMB message.

Request Message Type may have a size of 2 bytes. The Request Message Type may be a component indicating a type of request for the RPMB 110a. The Request Message Type may be included in a request that an initiator device transmits to a target device. Examples of possible Request Message Type code values are shown in the following Table 3.

TABLE 3

| Code | Request Message Types |
|---|---|
| 0001h | Authentication Key programming request |
| 0002h | Write Counter read request |
| 0003h | Authenticated data write request |
| 0004h | Authenticated data read request |
| 0005h | Result read request |
| 0006h | Secure Write Protect Configuration Block write request |
| 0007h | Secure Write Protect Configuration Block read request |
| Others | Reserved |

The Authentication Key programming request may be a request message type requesting an authentication key to be programmed. The Write Counter read request may be a request message type requesting a write count value stored in a write counter. The Authenticated data write request may be a request message type requesting data to be stored in the RPMB 110a. The Authenticated data read request may be a request message type requesting data stored in the RPMB 110a to be read. The Result read request may be a request message type requesting a performance result (a value stored in a result register) of an operation related to the RPMB 110a.

The Response Message Type may have a size of 2 bytes. The Response Message Type may be a component indicating a type of response. The Response Message Type may not be included in a request that the initiator device transmits to the target device, but may be included in a response that the target device transmits to the initiator device. Examples of possible Response Message Type code values are shown in following Table 4.

TABLE 4

| Code | Response Message Types |
|---|---|
| 0100h | Authentication Key programming response |
| 0200h | Write Counter read response |
| 0300h | Authenticated data write response |
| 0400h | Authenticated data read response |
| 0500h | Result read response |
| 0600h | Secure Write Protect Configuration Block write response |
| 0700h | Secure Write Protect Configuration Block read response |
| Others | Reserved |

The Authentication Key programming response may be a response message type indicating a response to the RPMB message requesting the authentication key to be programmed. The Write Counter read response may be a response message type indicating the RPMB message that transmits the write count value stored in the write counter to the initiator device. The Authenticated data write response may be a response message type indicating a response to the Authenticated data write request requesting data to be stored in the RPMB 110a. The Authenticated data read response may be a response message type indicating a response to the Authenticated data read request requesting the data stored in the RPMB 110a to be read. A Result read response may be a response message type indicating a response to the Result read request requesting a performance result (e.g., the value stored in the result register) of the operation related to the RPMB 110a.

The Authentication Key may have a size of 32 bytes. The Authentication Key may be an RPMB message component included in the UPIU corresponding to the Authentication Key programming request when programming to the RPMB 110a is initially requested. Therefore, the Authentication Key may be included only in the request that the initiator device transmits to the target device.

The Message Authentication Code (MAC) may have a size of 32 bytes. The MAC may be included in the response that the target device transmits to the initiator device, as well as the request that the initiator device transmits to the target device. The MAC may be an RPMB message component used for authentication.

The Result may have a size of 2 bytes. The Result may be a value stored in the result register included in the RPMB 110a. Therefore, the Result may be included in the response that the target device transmits to the initiator device.

The Write Counter may have a size of 4 bytes. The Write Counter may indicate a total number of successfully performed authenticated data write operations. The Write Counter may be the write count value stored in the write counter included in the RPMB 110a. The Write Counter may be included in the response that the target device transmits to the initiator device, as well as the request that the initiator device transmits to the target device.

The Address may have a size of 2 bytes. The Address may be data to be stored in the RPMB 110a or a logical address of the data stored in the RPMB 110a. The Address may be included in the response that the target device transmits to the initiator device, as well as the request that the initiator device transmits to the target device.

The Nonce may have a size of 16 bytes. The Nonce may be a random value. The Nonce may be included in the response that the target device transmits to the initiator device, as well as the request that the initiator device transmits to the target device. In an embodiment, the Nonce may be generated by the host 400, and the storage device 50 may copy and use the Nonce generated by the host 400.

The Data may be data to be stored in the RPMB 110a or data read from the RPMB 110a. The Data may have a size of 256 bytes. In an embodiment, the Data may be data transferred between the initiator device and the target device when the RPMB 110a is accessed in the normal RPMB mode.

Advanced RPMB Data may be data to be stored in the RPMB 110a or data read from the RPMB 110a in an advanced RPMB mode. The Advanced RPMB Data may be transmitted in a unit size of 4-KB. The Advanced RPMB Data may be data to be stored in the RPMB 110a according to the Authenticated data write request, or data that the storage device 50 reads from the RPMB 110a according to the Authenticated data read request.

The Block Count may have a size of 2 bytes. The Block Count may be a value indicating a number of blocks of data transferred between the initiator device and the target device in the normal RPMB mode. In a normal RPMB mode, one block may have a size of 256 bytes.

The Advanced RPMB Block Count may be a value indicating the number of blocks of Advanced RPMB Data transferred between the initiator device and the target device in the advanced RPMB mode. In the advanced RPMB mode, one block may have a size of 4 KB.

The RPMB message components described with reference to FIG. 6 may be included in the RPMB message transferred between the host 400 and the storage device 50 or between the initiator device and the target device when the RPMB is accessed in the normal RPMB mode, the advanced PRMB mode, or the high speed RPMB mode. The RPMB message components may be included in one UPIU or may be divided and included in a plurality of UPIUs according to the type of operation.

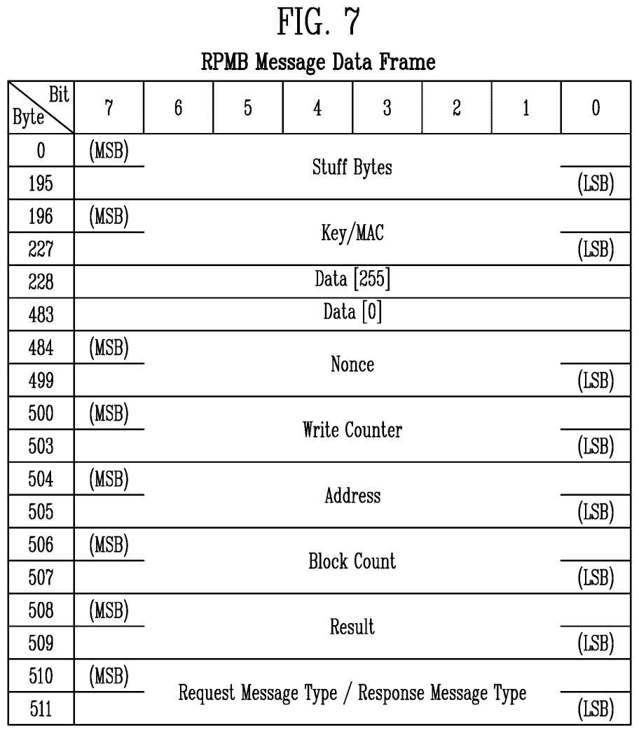

FIG. 7 is a diagram illustrating an RPMB message data frame constituting an RPMB message in accordance with an embodiment of the present disclosure.

Referring to FIG. 7, an RPMB message may include a plurality of RPMB message data frames. In FIG. 7, an RPMB message frame may have 512 bytes, but other sizes are possible in other embodiments.

The Authentication Key or the Message Authentication Code (MAC) may have a size of 32 bytes (196 to 227). The Data may have 256 bytes (228 to 483). The Nonce may have 16 bytes (484 to 499). The Write Counter may have 4 bytes (500 to 503). The Address may have 2 bytes (504 to 505). The Block Count may have 2 bytes (506 to 507). The Result may have 2 bytes (508 to 509). The Request Message Type and Response Message Type may have 2 bytes (510 to 511).

The Data, from among the components constituting the RPMB message data frame, may be data to be stored in the RPMB or data read from the RPMB. A size obtained by adding up the other components, except for the Data, may be 64 bytes or less.

FIG. 8 is a diagram illustrating a storage device in accordance with an embodiment of the present disclosure.

Referring to FIGS. 1 and 8, a storage device 50 may include an RPMB 110a and an RPMB device controller 210. A RPMB 110a may be at least one block from among the memory blocks included in a memory device 100 described above with reference to FIG. 1, and the RPMB device controller 210 may be included in a memory controller 200 described above with reference to FIG. 1. An RPMB host controller 410 may be included in a host 400 described above with reference to FIG. 1.

The RPMB 110a may include an authentication key 111, a write counter 112, a result register 113, and an RPMB data area 114.

The authentication key 111 may be stored initially and subsequently is not read without authentication. The authentication key 111 may be accessed only when a Message Authentication Code (MAC), which is used to authenticate access to only the RPMB 110a, is calculated. In an embodiment, the authentication key 111 may have a size of 32 bytes, but in other embodiments the size of the authentication key 111 is not limited to 32 bytes.

The write counter 112 may count a number of times an authenticated data write operation, which is an operation of storing data in the RPMB 110a, is successfully performed. A value indicated by the write counter 112 or a value stored in the write counter 112 may be a write count value. The write counter 112 may store a write count value corresponding to 4 bytes. However, the write counter 112 may store a write count value corresponding to data having a larger size. An initial write count value may be “0000 0000h.” The write count value of the write counter 112 may not be reset or decreased. The write count value of the write counter 112 may not be increased any more after the write count value reaches “FFFF FFFFh” as a maximum value. Therefore, when the write count value of the write counter 112 reaches the maximum value, no more data may be stored in the RPMB 110a, and the RPMB 110a may operate as a read-only block.

The result register 113 may store a result of an operation performed on the RPMB 110a. For example, the result register 113 May store a result code indicating a result of an operation performed on the RPMB 110a. Examples of result codes stored in the result register 113 are shown in the following Table 5.

TABLE 5

| Code | Description |
|---|---|
| 0000h (0080h) | Operation OK |
| 0000h (0081h) | General failure |
| 0000h (0082h) | Authentication failure. MAC comparison not matching, |
| | MAC calculation failure |
| 0000h (0083h) | Counter failure. Counters not matching in |
| | comparison, counter incrementing failure |
| 0000h (0084h) | Address failure. Address out of range, wrong address |
| | alignment |
| 0000h (0085h) | Write failure. Data/Counter/Result write failure |
| 0000h (0086h) | Read failure. Data/Counter/Result read failure |
| 0007h | Authentication Key not yet programmed. This value is |
| | the only valid Result value until the Authentication |
| | Key has been programmed. Once the key is |
| | programmed, this value will no longer be used. |
| 0008h (0088h) | Secure Write Protect Configuration Block access |
| | failure. Secure Write Protect Configuration read or |
| | write failure |
| 0009h (0089h) | Invalid Secure Write Protect Block Configuration |
| | parameter. Invalid LUN (or logical unit not enabled), |
| | DATA LENGTH, LOGICAL BLOCK ADDRESS, |
| | NUMBER OF LOGICAL BLOCKS, or overlapped areas |
| 000Ah (008Ah) | Secure Write Protection not applicable. Logical unit |
| | configured with other write protection modes |
| | (permanent or power-on) |

In an embodiment, the authentication key 111, the write counter 112, and the result register 113 may be independently determined for each RPMB 110a and have unique values. In various embodiments (not illustrated), the RPMB 110a may be partitioned into a plurality of RPMB regions. The maximum value of RPMB regions included in the RPMB 110a may be four. Each RPMB region may have a unique authentication key and a unique write count value.

The RPMB data area 114 may be an area in which data is stored only when authentication passes. In an embodiment, the capacity of the RPMB data area 114 may be a minimum of 128 Kbytes and a maximum of 16 Mbytes.

When an authenticated data write operation is performed, the RPMB host controller 410 may provide an RPMB message to the RPMB device controller 210 according to a predetermined format. The RPMB message provided by the RPMB host controller 410 may include information necessary for performing authentication on the RPMB 110a. For example, the RPMB message may include authenticated data. The authenticated data may include a Message Authentication Code (MAC) generated by the RPMB host controller 410.

The RPMB device controller 210 may include an authentication manager 211 and an access controller 212.

The authentication manager 211 may perform authentication, using the authentication key 111 stored in the RPMB 110a.

When the authenticated data write operation is performed, the authentication manager 211 may generate a Message Authentication Code (MAC), as authenticated data, using the authentication key 111 and meta data included in the RPMB message provided by the RPMB host controller 410. The authentication manager 211 may perform authentication by determining whether the generated MAC and the MAC included in the RPMB message provided by the RPMB host controller 410 are identical (or match).

The authentication manager 211 may provide a performance result of the authentication to the access controller 212. The access controller 212 may store data in the RPMB 110a or exclude the data from being stored in the RPMB 110a according to the result of the authentication.

When the authentication is successful, the access controller 212 may control the RPMB 110a and store data, which is received from the host 400 and stored in the RPMB 110a, in the RPMB data area 114. When the data is successfully stored, the access controller 212 may increase the write count value stored in the write counter 112, and store a result of the authenticated data write operation in the result register 113.

When the authentication fails, the access controller 212 does not store, in the RPMB data area 114, the data in the RPMB 110a that was requested to be stored. The access controller 212 may maintain the value of the write counter 112, and store, in the result register 113, information indicating that the authentication has failed.

When an authenticated data read operation is performed, the RPMB host controller 410 may provide an RPMB message to the RPMB device controller 210 according to a predetermined format.

The access controller 212 may read data stored in the RPMB 110a, and generate an RPMB message to be provided to the RPMB host controller 410. The access controller 212 may generate meta data to be included in the RPMB message. The meta data may include a portion of information included in the RPMB message received from the RPMB host controller 410, data read from the RPMB 110a, and a result code indicating a performance result of the authenticated data read operation. In an embodiment, the access controller 212 may generate a Message Authentication Code (MAC), as authenticated data, using the authentication key 111 stored in the RPMB 110a and the meta data.

The access controller 212 may generate an RPMB message including the authenticated data and the meta data. The access controller 212 may provide the read data and the RPMB message to the RPMB host controller 410.

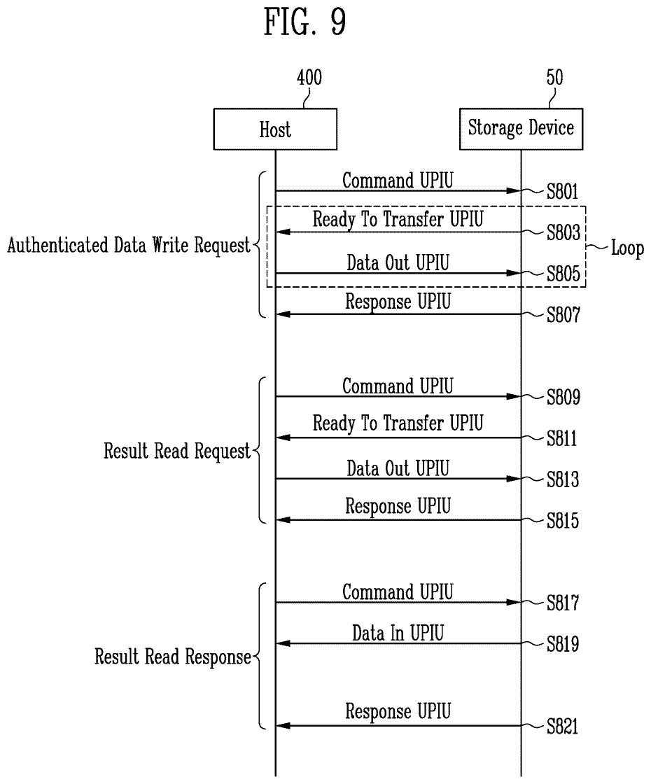

FIG. 9 is a flowchart illustrating an authenticated data write operation performed in a normal RPMB mode in accordance with an embodiment of the present disclosure.

Referring to FIGS. 1 and 9, in order to perform an authenticated data write operation in a normal RPMB mode, a host 400 may transfer a Command UPIU three times, and a storage device 50 may transfer a Response UPIU three times.

Specifically, the authenticated data write operation may include a process of exchanging RPMB messages of an authenticated data write request, a result read request, and a result read response through the UPIP.

The authenticated data write request may be performed through steps S801 to S807, the result read request may be performed through steps S809 to S815, and the result read response may be performed through steps S817 to S821.

The authenticated data write request may include a process in which the host 400 transfers, to the storage device 50, an RPMB message requesting data to be stored in the RPMB 110a and the data to be stored.

The result read request may be a request in which the host 400 transfers, to the storage device 50, an RPMB message requesting a value stored in the result register included in the RPMB 110a, in which a performance result of the authenticated data write operation is stored.

The result read response may be a response in which the storage device transfers, to the host 400, an RPMB message providing the value of the result register.

In step S801, the host 400 may provide a Command UPIU to the storage device 50. The Command UPIU transferred in step S801 may be a Security Protocol Out command indicating that the host 400 is to transfer data. In step S803, the storage device 50 may provide a Ready To Transfer UPIU to the host 400 in response to the Command UPIU received in step S801. The Ready To Transfer UPIU may be a UPIU provided when the storage device 50 is ready to receive the data to be provided by the host 400. In an embodiment, the Ready To Transfer UPIU may be a UPIU providing a message that the storage device 50 is ready to receive a Data Out UPIU.

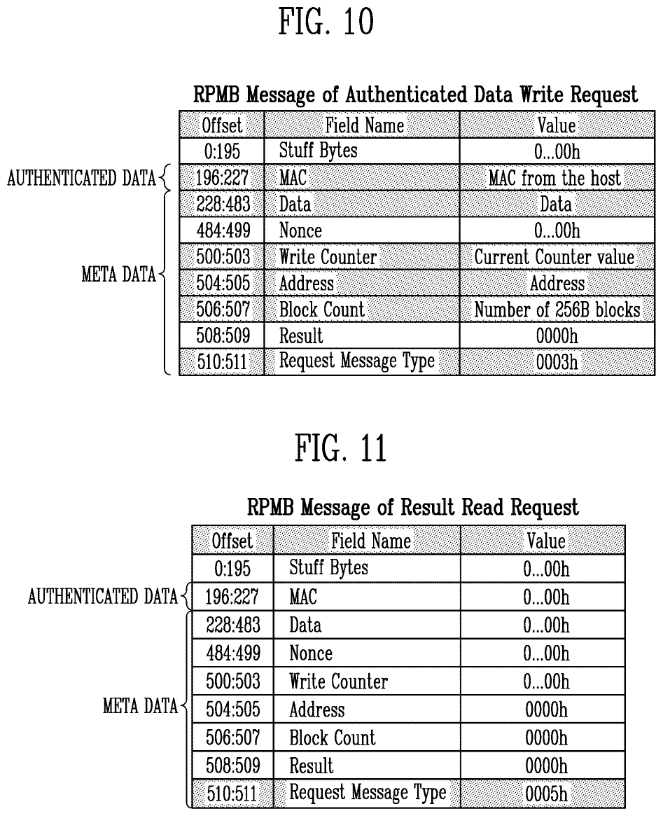

In step S805, the host 400 may provide a Data Out UPIU to the storage device 50. The Data Out UPIU provided by the host 400 may include an RPMB message corresponding to the authenticated data write request. The RPMB message transferred in the step S805 may include stuff bytes, authenticated data, and meta data. The meta data may include data to be stored in the RPMB 110a. FIG. 9 illustrates an authenticated data write operation performed in a normal RPMB mode, and therefore, the data may include a plurality of blocks having a size of 256 bytes. The RPMB message transferred in step S805 will be described in more detail later with reference to FIG. 10. Steps S803 and S805 may be performed repeatedly until data transmission is completed, according to the size of the data to be stored in the RPMB.

In step S807, the storage device 50 may provide a Response UPIU to the host 400. The Response UPIU transmitted in the step S807 may be a response to the Command UPIU transmitted in the step S801.

In step S809, the host 400 may provide a Command UPIU to the storage device 50. The Command UPIU transferred in the step S809 may be a Security Protocol Out command indicating that the host 400 is to transfer data. After that, in step S811, the storage device 50 may provide a Ready To Transfer UPIU to the host 400 in response to the Command UPIU received in step S809. The Ready To Transfer UPIU may be a UPIU provided when the storage device 50 is ready to receive data to be provided by the host 400. In an embodiment, the Ready To Transfer UPIU may be a UPIU providing a message that the storage device 50 is ready to receive a Data Out UPIU.

In step S813, the host 400 may provide a Data Out UPIU to the storage device 50. The Data Out UPIU provided in the step S813 may include an RPMB message corresponding to the result read request. In an embodiment, the RPMB message included in the Data Out UPIU provided in step S813 will be described in more detail later with reference to FIG. 11.

In step S815, the storage device 50 may provide a Response UPIU to the host 400. The Response UPIU transmitted in step S815 may be a response to the Command UPIU transmitted in step S809.

In step S817, the host 400 may provide a Command UPIU to the storage device 50. The Command UPIU provided in step S817 may be a Security Protocol In command indicating that the Command UPIU is a command for requesting data or information from the storage device 50.

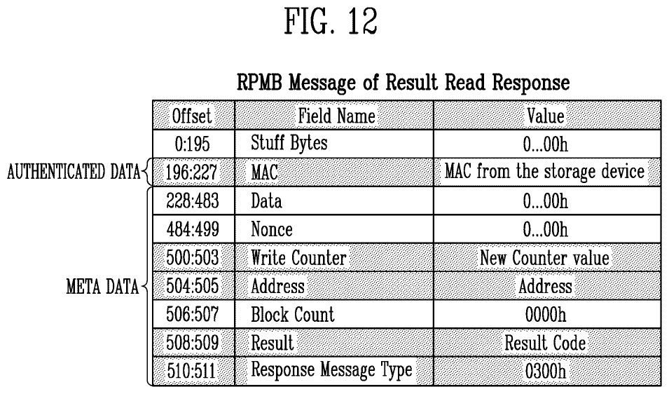

In step S819, the storage device 50 may provide a Data In UPIU to the host 400. The Data In UPIU transferred in the step S819 may include an RPMB message corresponding to the result read request. The RPMB message transferred in step S819 may include stuff byes, authenticated data, and meta data. The meta data may include an updated write count value and a value of the result register, which indicates a result of performing the authenticated data write operation. The RPMB message transferred in step S819 will be described in more detail later with reference to FIG. 12.

In step S821, the storage device 50 may provide a Response UPIU to the host 400. The Response UPIU transmitted in step S821 may be a response to the Command UPIU transmitted in step S817.

FIG. 10 is a diagram illustrating an RPMB message provided through step S805 shown in FIG. 9 in accordance with an embodiment of the present disclosure.

Referring to FIGS. 1, 9, and 10, an RPMB message corresponding to an authenticated data write operation may include stuff bytes, authenticated data, and meta data.

The stuff bytes may be bits added to adjust a fixed data format or synchronization of data communication. In an embodiment, a field corresponding to the stuff bytes may be “0.”

The authenticated data included in the RPMB corresponding to the authenticated data write operation may be a MAC generated by the RPMB host controller 410, which is described above with reference to FIG. 7.

The meta data may include data to be stored in the RPMB 110a, a nonce, a current write count value, an address corresponding to the data, a number of blocks of data (one block is 256 bytes), and a request message type indicating that the RPMB message corresponds to the authenticated data write request. In an embodiment, a field corresponding to the nonce may be “0.”

The meta data along with the authentication key 111 may be used by the access controller 212 to calculate the MAC, which is described above with reference to FIG. 8.

FIG. 11 is a diagram illustrating an RPMB message provided through step S813 shown in FIG. 9 in accordance with an embodiment of the present disclosure.

Referring to FIGS. 1, 9, and 11, an RPMB message corresponding to a result read request may include stuff bytes, authenticated data, and meta data.

In an embodiment, the RPMB message corresponding to the result read request may have only a request message type included in the meta data, and values of the other fields may be “0.” The request message type may include a code value (0005h) indicating that the RPMB message corresponds to the result read request.

FIG. 12 is a diagram illustrating an RPMB message provided through step S819 shown in FIG. 9 in accordance with an embodiment of the present disclosure.

Referring to FIGS. 1, 9, and 12, an RPMB message corresponding to a result read response may include stuff byes, authenticated data, and meta data.

The stuff bytes may be bits added to adjust a fixed data format or synchronization of data communication. In an embodiment, a field corresponding to the stuff bytes may be “0.”

The authenticated data included in the RPMB corresponding to the result read response may be a MAC generated by a RPMB device controller 210 described above with reference to FIG. 8.

Specifically, an access controller 212 may generate meta data to be included in the RPMB message and generate a MAC using the generated meta data and the authentication key 111 stored in the RPMB 110a.

The meta data may include an updated write count value, an address of data stored by the authenticated data write operation, a result code indicating a result of performing the authenticated data write operation, and “0300h” as a response message type code indicating that the RPMB message corresponds to the authenticated data write response. The address may have a value equal to a value of the address included in the RPMB message corresponding to the authenticated data write request described above with reference to FIG. 10.

In an embodiment, values of stuff bytes, data, nonce, and block count fields may be “0.”

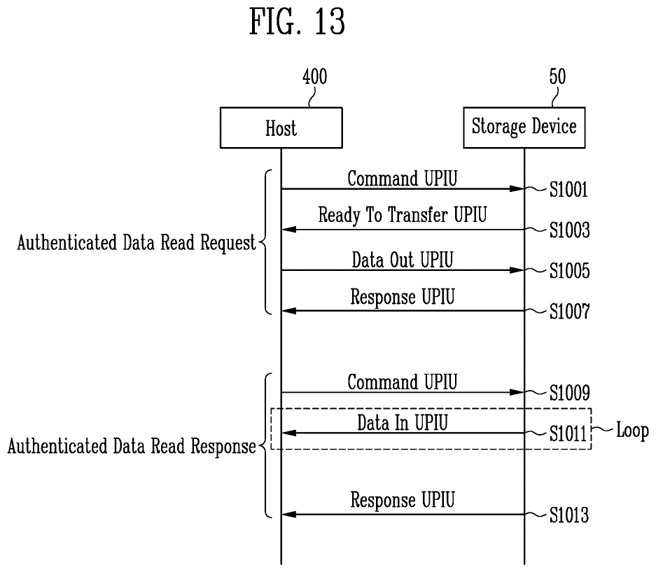

FIG. 13 is a flowchart illustrating an authenticated data read operation performed in a normal RPMB mode in accordance with an embodiment of the present disclosure.

Referring to FIGS. 1 and 13, in performing an authenticated data read operation in a normal RPMB mode, a host 400 may transfer a Command UPIU twice, and a storage device 50 may transfer a Response UPIU twice.

Specifically, the authenticated data read operation may include a process of exchanging RPMB messages corresponding to an authenticated data read request and an authenticated data read response, respectively, through UPIU transmissions.

The authenticated data read request may be performed through steps S1001 to S1007, and the authenticated data read response may be performed through steps S1009 to S1013.

The authenticated data read request may include a process in which the host 400 transfers, to the storage device 50, an RPMB message indicating a read request for data stored in the RPMB 110a, and the authenticated data read response may include a process in which the storage device 50 transfers data read from the RPMB 110a to the host 40.

In step S1001, the host 400 may provide a Command UPIU to the storage device 50. The Command UPIU provided in step S1001 may be a Security Protocol Out command indicating that the host 400 is to transfer data.

In step S1003, the storage device 50 may provide a Ready To Transfer UPIU to the host 400.

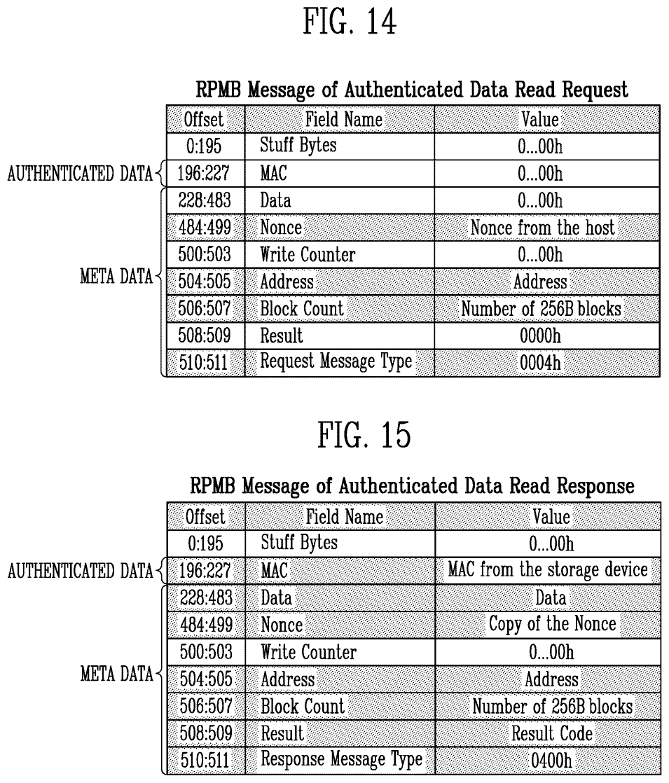

In step S1005, the host 400 may provide a Data Out UPIU to the storage device 50. The Data Out UPIU provided in step S1005 may include an RPMB message. Specifically, the RPMB message provided in step S1005 may include meta data. The meta data may include a nonce generated by the host 400, an address of data to be read, a block count indicating a block number of the data to be read, and a request message type indicating that the RPMB message corresponds to the authenticated data read request. The RPMB message corresponding to the authenticated data read request will be described in more detail later with reference to FIG. 14.

In step S1007, the storage device 50 may provide a Response UPIU to the host 400. The Response UPIU provided by the storage device 50 may be a response to the Command UPIU received in step S1001.

In step S1009, the host 400 may provide a Command UPIU to the storage device 50. The Command UPIU provided in step S1009 may be a Security Protocol In command indicating that the Command UPIU is a command for requesting data or information from the storage device 50.

In step S1011, the storage device 50 may provide a DATA In UPIU to the host 400. The Data In UPIU provided by the storage device 50 may include an RPMB message. Specifically, the RPMB message provided in step S1011 may include stuff bytes, authenticated data, and meta data. The authenticated data may be an MAC generated by the storage device 50. The meta data may include data read from the RPMB 110a, a nonce, an address, a block count indicating the number of blocks of read data, and a response message type indicating that the RPMB message corresponds to the authenticated data read response. The RPMB message corresponding to the authenticated data read response will be described in more detail later with reference to FIG. 15.

In step S1013, the storage device 50 may provide a Response UPIU to the host 400. The Response UPIU received by the host 400 in the step S1013 may be a response to the Command UPIU received in step S1009.

FIG. 14 is a diagram illustrating an RPMB message provided through step S1005 shown in FIG. 13 in accordance with an embodiment of the present disclosure.

Referring to FIGS. 1, 13, and 14, an RPMB message corresponding to an authenticated data read request may include meta data and stuff bytes without authentication data. The stuff bytes may be bits added to adjust a fixed data format or synchronization of data communication. In an embodiment, a field corresponding to the stuff bytes may be “0.”

The meta data may include a nonce generated by a host 400, an address of data to be read, a block count indicating the number of blocks of read data, and a request message type indicating that the RPMB message corresponds to the authenticated data read request.

In various embodiments, values respectively corresponding to stuff bytes, an MAC, data, a write counter, and a result, which are included in the RPMB message corresponding to the authenticated data read request, may be “0.”

FIG. 15 is a diagram illustrating an RPMB message provided through step S1011 shown in FIG. 13 in accordance with an embodiment of the present disclosure.

Referring to FIGS. 1, 13, and 15, an RPMB message corresponding to an authenticated data read response may include authenticated data and meta data. The authenticated data may be a MAC generated by a RPMB device controller 210. The meta data may include data read from a RPMB 110a, a nonce, an address, a block count indicating the number of blocks of read data, a result, and a response message type indicating that the RPMB message corresponds to the authenticated data read response.

The nonce may be a nonce included in the RPMB message corresponding to the authenticated data read request transferred through step S1005, i.e., a value obtained by copying a nonce value generated by a host 400 as is. The address and the block count of the read data may be values equal to an address of data to be read, which is included in the RPMB message corresponding to the authenticated data read request, and a block count indicating the number of blocks of read data. The result may be a result code indicating a result of performing the authenticated data read operation. The response message type may be a code (0400h) indicating that the RPMB message corresponds to the authenticated data read response.

The RPMB host controller 410 included in the host 400 may receive an RPMB message including data read according to the authenticated data read operation, and then calculate a MAC, using an authentication key of the RPMB host controller 410 and meta data included in the RPMB message. The RPMB host controller 410 may acquire the read data only when the MAC calculated by the RPMB host controller 410 and a MAC generated by a storage device 50, as authenticated data included in the RPMB message, are the same (or match).

As described with reference to FIGS. 9 to 15, in an authenticated data write operation and an authenticated data read operation in a normal RPMB mode, data to be stored and a Command UPIU for providing read data may be provided once, but an additional Command UPIU or Response UPIU may be necessary to transfer the RPMB message. This may cause delay of access speed to the RPMB 110a and increase design complexity.

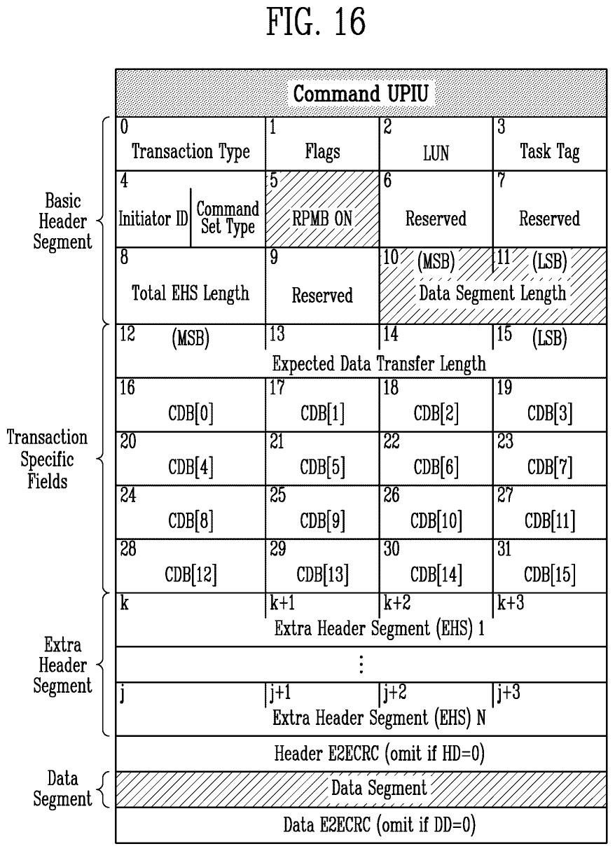

FIG. 16 is a diagram illustrating a configuration of a Command UPIU in accordance with an embodiment of the present disclosure.

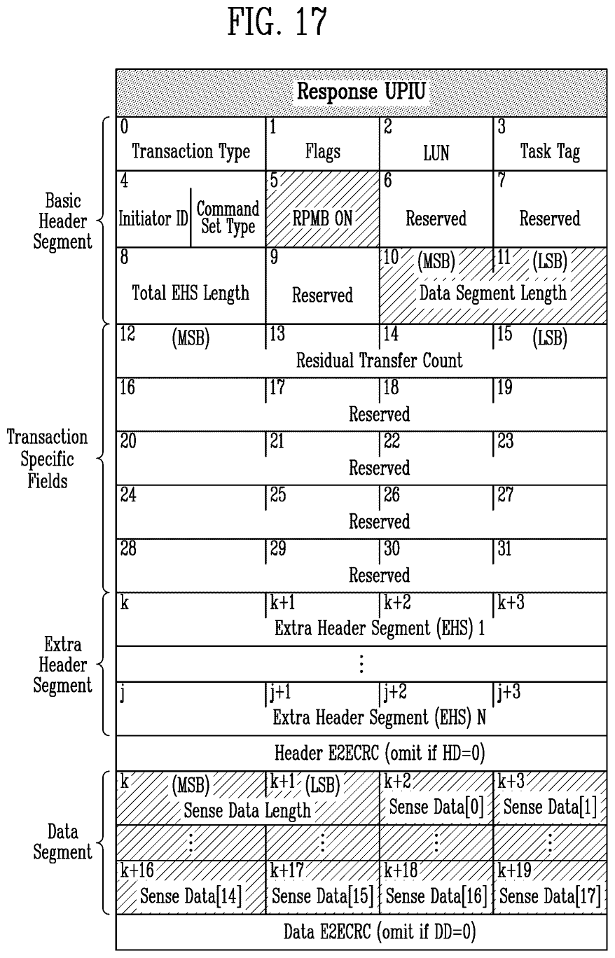

FIG. 17 is a diagram illustrating a configuration of a Response UPIU in accordance with an embodiment of the present disclosure. Referring to FIGS. 1, 16, and 17, each of a Command UPIU and a Response UPIU may include a basic header segment, transaction specific fields, an extra header segment, and a data segment.

In an embodiment, the extra header segment (EHS) and a total EHS length field may be used in an advanced RPMB mode.

The basic header segment included in each of the Command UPIU and the Response UPIU may include a total EHS length field. When the total EHS length field has a value that is not 0, the extra header segment is included in each of the Command UPIU and the Response UPIU.

The extra header segment may be started from byte address 32 of the UPIU. The extra header segment may be an area in which additional information can be included besides the information contained in the basic header segment.

In an embodiment, the data segment and a data segment length field may be used in a high speed RPMB mode.

The basic header segment included in each of the Command UPIU and the Response UPIU may include a data segment length field. When the data segment length field has a non-zero value, the data segment included in each of the Command UPIU and the Response UPIU may be used.

Specifically, the host 400 and the storage device 50 may transfer an RPMB message, using the data segment included in each of the Command UPIU and the Response UPIU. The host 400 and the storage device 50 may set the data segment length field included in the basic header segment of each of the Command UPIU and the Response UPIU to a value that is not 0, and transmit the data segment, which allows the RPMB message to be included therein.

The data segment length field may indicate an effective byte number in the data segment. When the byte number in the data segment is not a multiple of 4, a last 32-bit field may be filled with 0 and then terminated at a second closest 32-bit boundary. The number of 32-bit units (DWORDS) constituting the data segment may be calculated as follows.

$$Equation 1$$

$$DataSegmentDWORDS = INTEGER ( \frac{DataSegmentLength + 3}{4} )$$

The size of the data segment length field may be 2 bytes. The data segment may include a maximum of 65,535 effective bytes. When the value of the data segment length field is 0, this may indicate that no data segment exists in the UPIU.

The data segment may be started at a next 32-bit (DWORD) boundary behind an extra header segment area in the UPIU. The data segment may be a multiple of 32 bits. A value that is not a multiple of 4 bytes may be included in the data segment length field, however, the data segment may be filled with 0 up to the second closest 32-bit (DWORD) boundary.

In various embodiments, whether the high speed RPMB mode is to be used may be checked by using a fifth byte included in the basic header segment. That is, the host 400 and the storage device 50 may determine whether the value of the fifth byte included in the basic header segment of the Response UPIU is a non-zero value, and check that the high speed RPMB mode is used when a value that is not 0 is included in the basic header segment.

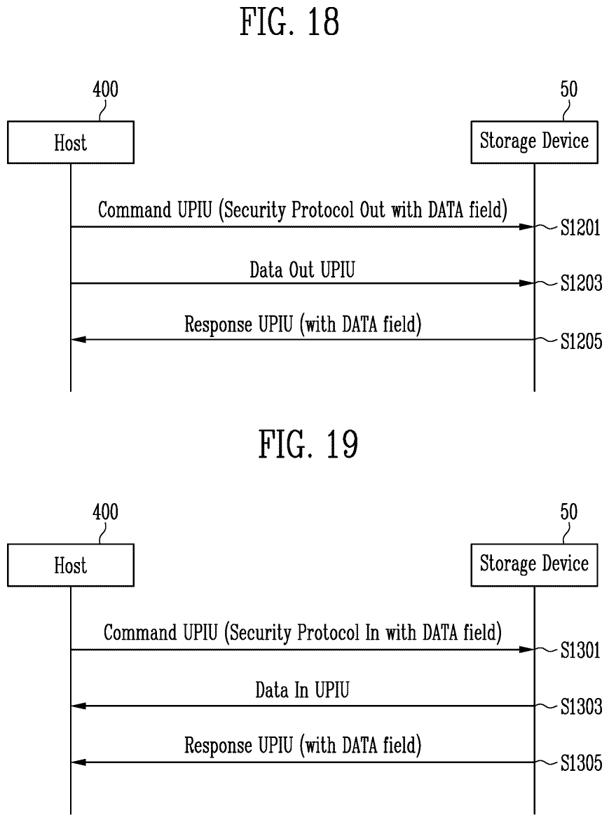

FIG. 18 is a flowchart illustrating an authenticated data write operation performed in a high speed RPMB mode in accordance with an embodiment of the present disclosure.

Referring to FIGS. 1 and 18, in step S1201, a host 400 may provide a Command UPIU to a storage device 50. The Command UPIU may include an RPMB message in a data segment. The Command UPIU may be a Security Protocol Out command indicating that the host 400 is to transfer data. The RPMB message transferred in step S1201 may be the RPMB message corresponding to an authenticated data write request described above with reference to FIG. 10.

In step S1203, the host 400 may provide a Data Out UPIP to the storage device 50. In a high speed RPMB, the host 400 has already provided the storage device 50 with the data segment that allows the RPMB message to be included therein in step S1201. Therefore, the Data Out UPIU transferred in step S1203 does not include the RPMB message but may include only data to be stored in the RPMB 110a.

In an embodiment, in an advanced RPMB mode, the storage device may provide a Ready To Transfer UPIU to the host 400 before the host 400 provides the Data Out UPIU to the storage device 50 in step S1203. The Ready To Transfer UPIU may be a protocol information unit transmitted when the storage device 50 is ready to receive the Data Out UPIU from the host 400. However, in the high speed RPMB mode in accordance with embodiments of the present disclosure, after the host 400 provides the Command UPIU to the storage device 50 in step S1201, in step S1203, the host 400 may provide the Data Out UPIU to the storage device 50 without the step in which the storage device 50 provides the Ready To Transfer UPIU to the host 400.

Therefore, in the high speed RPMB mode, the storage device 50 does not provide the Ready To Transfer UPIU to the host 400 as compared with the advanced RPMB mode. Hence, the performance of a faster operation is possible.

In step S1205, the storage device 50 may provide a Response UPIU to the host 400. The Response UPIU provided by the storage device 50 may include an RPMB message. The RPMB message transferred in step S1205 may be the RPMB message corresponding to the result read response described with reference to FIG. 12. The RPMB message may be included in a data segment of the Response UPIU.

In the advanced RPMB mode, the host 400 and the storage device 50 may provide an extra header segment that allows the RPMB message to be included therein. In the high speed RPMB mode in accordance with embodiments of the present disclosure, the host 400 and the storage device 50 may provide a data segment that allows the RPMB message to be included therein. Therefore, a storage device 50 supporting the advanced RPMB mode may require a hardware design change to use an extra header segment, or require additional hardware. However, in the high speed RPMB mode in accordance with embodiments of the present disclosure, a data segment included in a previously defined command is used, and therefore, a change to the design of hardware is not required. That is, the storage device 50 supporting an existing normal RPMB mode can support a high speed RPMB mode only by updating software, which is advantageous.

FIG. 19 is a flowchart illustrating an authenticated data read operation performed in a high speed RPMB mode in accordance with an embodiment of the present disclosure.

Referring to FIGS. 1 and 19, in step S1301, a host 400 may provide a Command UPIU to a storage device 50. The Command UPIU may include an RPMB message in a data segment. The Command UPIU may be a Security Protocol In command indicating that the host 400 requests data transferred from the storage device 50. The RPMB message transferred in step S1301 may be the RPMB message corresponding to the authenticated data read request described above with reference to FIG. 14.

In step S1303, the storage device 50 may read data stored in the RPMB 110a, using the RPMB message included in the Command UPIU received in step S1301, and provide the host 400 with a Data In UPIU including the read data. In step S1301, the host 400 has provided the storage device 50 with the data segment of the Command UPIU, which allows the RPMB message to be included therein. Therefore, the Data In UPIU transferred in step S1303 does not include the RPMB message, but can include the data only read from the RPMB 110a.

In step S1305, the storage device 50 may provide a Response UPIU to the host 400. The Response UPIU provided by the storage device 50 may include an RPMB message. The RPMB message may be included in a data segment of the Response UPIU. The RPMB message, which the storage device 50 provides to the host 400 in step S1305, may be the RPMB message corresponding to the authenticated data read response described above with reference to FIG. 15.

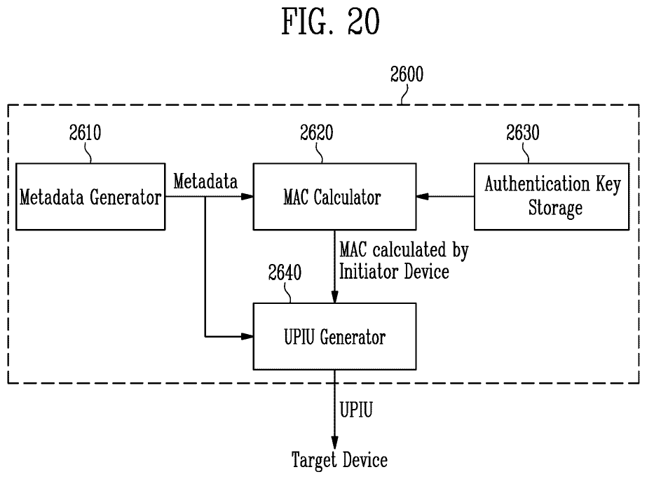

FIG. 20 is a diagram illustrating a UPIU transmitter 2600 included in an initiator device in accordance with an embodiment of the present disclosure.

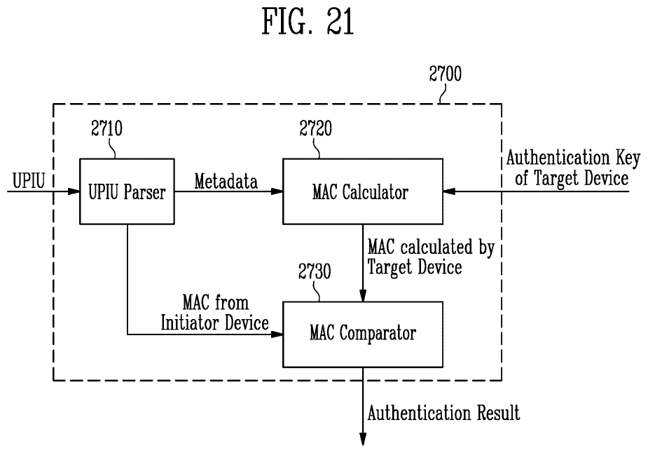

Referring to FIGS. 8 and 20, a host 400 and a storage device 50 may perform an operation related to an RPMB 110a while transmitting/receiving a UPIP. In performing an authenticated data write operation and an authenticated data read operation, which are described above with reference to FIGS. 9 to 19, both an RPMB host controller 410 and an RPMB device controller 210 may generate UPIUs, and perform authentication by transmitting a generated UPIU or by receiving a UPIU transmitted by the other device. Therefore, the RPMB host controller 410 and the RPMB device controller 210 may include both a UPIU transmitter 2600 and a UPIU receiver 2700 which will be described below with reference to FIG. 21.

A device that generates a UPIU may be an initiator device. A device that receives the generated UPIU may be a target device. When the RPMB host controller 410 provides an UPIU to the RPMB device controller 210, the host 400 may be an initiator device, and the storage device may be a target device. When the RPMB device controller 210 provides an UPIU to the RPMB host controller 410, the storage device 50 may be an initiator device, and the host 400 may be a target device.

The UPIU transmitter 2600 may include an MAC calculator 2620, an authentication key storage 2630, a metadata generator 2610, and a UPIU generator 2640.

The authentication key storage 2630 may store an authentication key. The authentication key storage 2630 may correspond to an authentication key 111 included in an RPMB 110a described above with reference to FIG. 8. Since the authentication key is used to generate a MAC when an authenticated data write operation and an authenticated data read operation are performed, the authentication key is stored in the RPMB 110a before the authenticated data write operation and the authenticated data read operation are performed.

The metadata generator 2610 may generate meta data. The meta data may be included in an RPMB message. The meta data may include different components according to the type of RPMB message. The components to be included in the meta data may include at least one of a write count value, a request message type, a response message type, a result, an address, a nonce, data, an advanced RPMB data, a block count, and an advanced RPMB block count, which are described above with reference to FIG. 6.

The metadata generator 2610 may provide generated meta data to the MAC calculator 2620 and the UPIU generator 2640.

The MAC calculator 2620 may generate a MAC, using the meta data and the authentication key stored in the authentication key storage 2630. Specifically, the MAC calculator 2620 may generate the MAC, using a hash-based message authentication code (HMAC SHA-256). The generated MAC may be used by the target device to perform authentication. The MAC may have a length of 256 bits (32 bytes). The authentication key used to generate the MAC may be 256 bits. However, the size of the MAC and the size of the authentication key are not limited in size to 256 bits and sizes may vary in other embodiments. The MAC calculator 2620 may provide the generated MAC to the UPIU generator 2640.

The UPIU generator 2640 may generate a UPIU to be provided to the target device. Specifically, the UPIU generator 2640 may generate an RPMB message including authenticated data and meta data. The authenticated data may be the MAC generated by the MAC calculator 2620.

In a normal RPMB mode, the UPIU generator 2640 may provide the generated RPMB message to the target device through a Data In UPIU or a Data Out UPIU.

In an advanced RPMB mode, the UPIU generator 2640 may generate a UPIU in which an RPMB message is included in an extra header segment, and provide the generated UPIU to the target device. In the advanced RPMB mode, a total EHS length in a basic header segment of the UPIU including the RPMB message may be a value that is not 0.

In a high speed RPMB mode, the UPIU generator 2640 may generate a UPIU in which an RPMB message is included in a data segment, and provide the generated UPIU to the target device. In the high speed RPMB mode, a total EHS length in a basic header segment of the UPIU including the RPMB message may be a value which is not 0. In various embodiments, in the high speed RPMB mode, the basic header segment of the UPIU including the RPMB message may include information indicating that the RPMB message is included in the data segment. In various embodiments, in the high speed RPMB mode, the basic header segment of the UPIU including the RPMB message may include information indicating that an RPMB operation mode is a high speed RPMB mode.

FIG. 21 is a diagram illustrating a UPIU receiver included in a target device in accordance with an embodiment of the present disclosure.

Referring to FIGS. 8 to 21, a host 400 and a storage device 50 may perform an operation related to an RPMB 110a while transmitting/receiving a UPIP. In performing an authenticated data write operation and an authenticated data read operation, which are described above with reference to FIGS. 9 to 19, both an RPMB host controller 410 and an RPMB device controller 210 may generate UPIUs, and perform authentication by transmitting a generated UPIU or by receiving a UPIU transmitted by the other device. Therefore, the RPMB host controller 410 and the RPMB device controller 210 may include both a UPIU transmitter 2600 described above with reference to FIG. 20 and a UPIU receiver 2700.

A device that generates a UPIU may be an initiator device. A device that receives the generated UPIU may be a target device. When the RPMB host controller 410 provides a UPIU to the RPMB device controller 210, the host 400 may be an initiator device, and the storage device may be a target device. When the RPMB device controller 210 provides an UPIU to the RPMB host controller 410, the storage device 50 may be an initiator device, and the host 400 may be a target device.

The UPIU receiver 2700 may include a UPIU parser 2710, an MAC calculator 2720, and an MAC comparator 2730.

The UPIU parser 2710 may receive a UPIU provided by an initiator device. The UPIU received by the UPIU parser 2710 may be a Data In UPIU or a Data Out UPIU in a normal RPMB mode. The UPIU received by the UPIU parser 2710 may be a Command UPIU or a Response UPIU in an advance RPMB mode or a high speed RPMB mode.

The UPIU parser 2710 may acquire an RPMB message by parsing the received UPIU, and acquire meta data and authenticated data, which are obtained by parsing the RPMB message. In an embodiment, the meta data may include different components according to the RPMB message type. The components in the meta data may include at least one of a write count value, a request message type, a response message type, a result, an address, a nonce, data, an advanced RPMB data, a block count, and an advanced RPMB block count, which are described above with reference to FIG. 6.

The authenticated data may be a MAC generated by the initiator device. In an embodiment, authenticated data included in an RPMB corresponding to an authentication key programming request, which is provided in an authentication key programming operation, may be the authentication key itself.

The MAC calculator 2720 may acquire an authentication key previously stored in the target device. The authentication key previously stored in the target device may have the same value as an authentication key stored in the initiator device.

The MAC calculator 2720 may calculate a MAC, using the meta data received from the UPIU parser 2710 and the authentication key previously stored in the target device. For example, the MAC calculator 2720 may calculate the MAC using a hash-based message authentication code (HMAC SHA-256). The MAC calculator 2720 may provide the calculated MAC to the MAC comparator 2730.

The MAC comparator 2730 may compare the MAC received from the UPIU parser 2710 with the MAC received from the MAC calculator 2720 and output an authentication result based on the comparison. A successful authentication result may result in performance of an authenticated data write operation or an authenticated data read operation on the RPMB.

When authentication keys stored in the initiator device and the target device are different from each other, or when meta data used to calculate MACs are different from each other, authentication may fail. The authentication succeeds only when the authentication keys stored in the initiator device and the target device are the same (or match) and when the meta data used to calculate the MACs are the same (or match). Thus, the RPMB 110a can provide a data storage function that also provides a high degree of security.

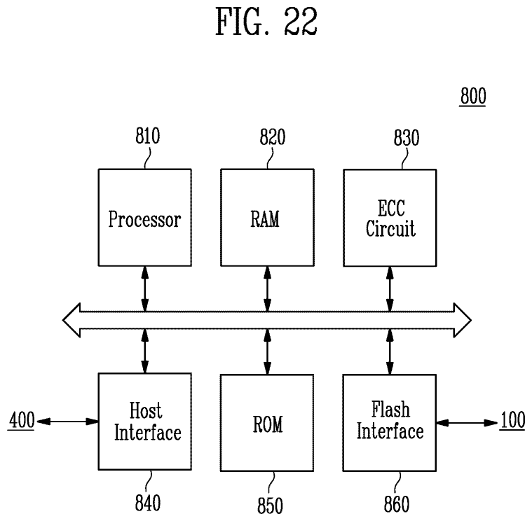

FIG. 22 is a diagram illustrating an embodiment of a memory controller shown in FIG. 1 in accordance with an embodiment of the present disclosure.

Referring to FIG. 22, a memory controller 800 may include a processor 810, a random access memory (RAM) 820, an Error Correction Code (ECC) circuit 830, a host interface 840, a read only memory (ROM) 850, and a flash interface 860.

The processor 810 may control a general operation of the memory controller 800. The RAM 820 may be used as a buffer memory, a cache memory, a working memory, or the like of the memory controller 800.

The ROM 850 may store various types of information required to operate for the memory controller 800 in the form of firmware.

The memory controller 800 may communicate with an external device (e.g., a host 400, an application processor, or the like) through the host interface 840.

The memory controller 800 may communicate with the memory device 100 through the flash interface 860. The memory controller 800 may transmit a command CMD, an address ADDR, a control signal CTRL, and the like to a memory device 100 through the flash interface 860, and receive data DATA. As an example, the flash interface 860 may include a NAND interface.

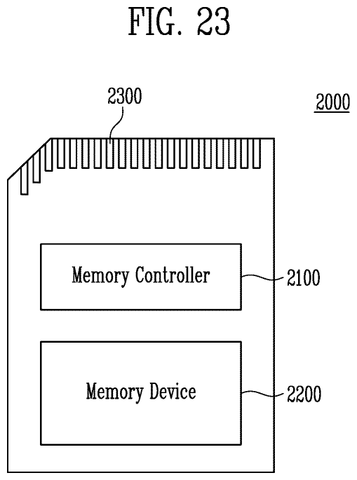

FIG. 23 is a block diagram illustrating a memory card system to which a storage device in accordance with an embodiment of the present disclosure is applied.

Referring to FIG. 23, a memory card system 2000 includes a memory controller 2100, a memory device 2200, and a connector 2300.

The memory controller 2100 may be connected to the memory device 2200. The memory controller 2100 may access the memory device 2200. For example, the memory controller 2100 may control read, program, erase, and background operations of the memory device 2200. The memory controller 2100 provides an interface between the memory device 2200 and a host. The memory controller 2100 drives firmware for controlling the memory device 2200. The memory controller 2100 may be implemented as a memory controller 200 described above with reference to FIG. 1.

The memory controller 2100 may include components such as a Random Access Memory (RAM), a processing unit, a host interface, a memory interface, and an ECC circuit.

The memory controller 2100 may communicate with an external device through the connector 2300. The memory controller 2100 may communicate with the external device (e.g., the host) according to a specific communication protocol. The memory controller 2100 may communicate with the external device through at least one of various communication protocols such as a Universal Serial Bus (USB), a Multi-Media Card (MMC), an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), firewire, a Universal Flash Storage (UFS), Wi-Fi, Bluetooth, and NVMe. The connector 2300 may be defined by at least one of the above-described various communication protocols.

The memory device 2200 may be implemented with various nonvolatile memory devices such as an Electrically Erasable and Programmable ROM (EEPROM), a NAND flash memory, a NOR flash memory, a Phase-change RAM (PRAM), a Resistive RAM (ReRAM), a Ferroelectric RAM (FRAM), and a Spin Torque Transfer magnetic RAM (STT-MRAM).

The memory controller 2100 and the memory device 2200 may be integrated into a single semiconductor device used in a memory card. For example, the memory controller 2100 and the memory device 2200 may be included a memory card such as a PC card (Personal Computer Memory Card International Association (PCMCIA)), a Compact Flash (CF) card, a Smart Media Card (SM or SMC), a memory stick, a Multi-Media Card (MMC, RS-MMC, MMCmicro of eMMC), an SD card (SD, miniSD, microSD or SDHC), and a Universal Flash Storage (UFS).

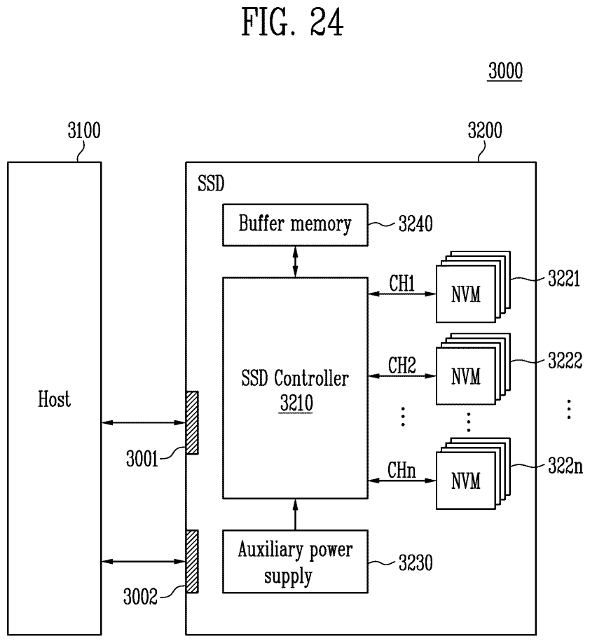

FIG. 24 is a block diagram illustrating a Solid State Drive (SSD) system to which a storage device in accordance with an embodiment of the present disclosure is applied.

Referring to FIG. 24, an SSD system 3000 includes a host 3100 and an SSD 3200. The SSD 3200 exchanges a signal with the host 3100 through a signal connector 3001, and receives power through a power connector 3002. The SSD 3200 includes an SSD controller 3210, a plurality of flash memories 3221 to 322n, an auxiliary power supply 3230, and a buffer memory 3240.

In accordance with an embodiment of the present disclosure, the SSD controller 3210 may serve as a memory controller 200 described above with reference to FIG. 1.

The SSD controller 3210 may control the plurality of flash memories 3221 to 322n in response to a signal received from the host 3100. The signal may be a signal based on an interface between the host 3100 and the SSD 3200. For example, the signal may be a signal defined by at least one of various interfaces such as a Universal Serial Bus (USB), a Multi-Media Card (MMC), an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), a firewire, a Universal Flash Storage (UFS), a WI-FI, a Bluetooth, and an NVMe.

The auxiliary power supply 3230 is connected to the host 3100 through the power connector 3002. When the supply of power from the host 3100 is not steady, the auxiliary power supply 3230 may provide power for the SSD 3200. The auxiliary power supply 3230 may be located in the SSD 3200 or located outside of the SSD 3200. For example, the auxiliary power supply 3230 may be located on a main board, and provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or temporarily store meta data (e.g., a mapping table) of the flash memories 3221 to 322n. The buffer memory 3240 may include volatile memories such as a DRAM, an SDRAM, a DDR SDRAM, an LPDDR SDRAM, and a GRAM or nonvolatile memories such as a FRAM, a ReRAM, an STT-MRAM, and a PRAM.

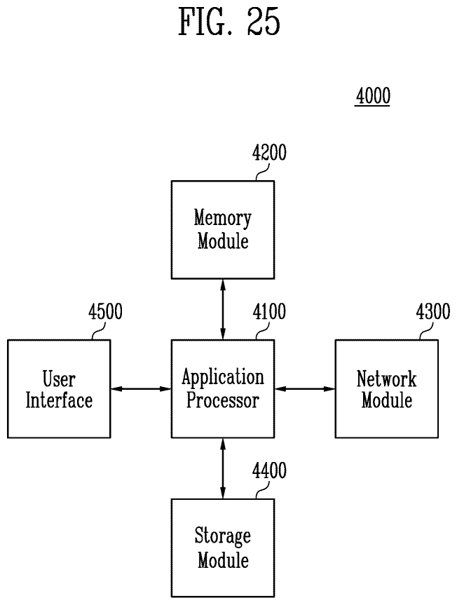

FIG. 25 is a block diagram illustrating a user system to which a storage device in accordance with an embodiment of the present disclosure is applied.

Referring to FIG. 25, a user system 4000 includes an application processor 4100, a memory module 4200, a network module 4300, a storage module 4400, and a user interface 4500.

The application processor 4100 may drive components included in the user system 4000, an operating system (OS), a user program, or the like. The application processor 4100 may include controllers for controlling components included in the user system 4000, interfaces, a graphic engine, and the like. The application processor 4100 may be provided as a System-on-Chip (SoC).

The memory module 4200 may operate as a main memory, working memory, buffer memory or cache memory of the user system 4000. The memory module 4200 may include volatile random access memories such as a DRAM, an SDRAM, a DDR SDRAM, a DDR2 SDRM, a DDR3 SDRAM, an LPDDR SDRAM, an LPDDR2 SDRAM, and an LPDDR3 SDRAM or nonvolatile random access memories such as a PRAM, a ReRAM, an MRAM, and a FRAM. The application processor 4100 and the memory module 4200 may be provided as one semiconductor package by being packaged based on a Package on Package (POP).

The network module 4300 may communicate with external devices. The network module 4300 may support wireless communications such as Code Division Multiple Access (CDMA), Global System for Mobile communication (GSM), Wideband CDMA (WCDMA), CDMA-2000, Time Division Multiple Access (TDMA), Long Term Evolution (LTE), Wimax, WLAN, UWB, Bluetooth, and Wi-Fi. The network module 4300 may be included in the application processor 4100.

The storage module 4400 may store data. For example, the storage module 4400 may store data received from the application processor 4100. Alternatively, the storage module 4400 may transmit data stored therein to the application processor 4100. The storage module 4400 may be implemented with a nonvolatile semiconductor memory device such as a Phase-change RAM (PRAM), a Magnetic RAM (MRAM), a Resistive RAM (RRAM), a NAND flash, a NOR flash, or a NAND flash having a three-dimensional structure. The storage module 4400 may be provided as a removable drive such as a memory card of the user system 4000 or an external drive.

The storage module 4400 may include a plurality of nonvolatile memory devices, and the plurality of nonvolatile memory devices may operate identically to a memory device 100 described above with reference to FIG. 1. The storage module 4400 may operate identically to a storage device 50 described above with reference to FIG. 1.

The user interface 4500 may include interfaces for inputting data or commands to the application processor 4100 or outputting data to an external device. The user interface 4500 may include user input interfaces such as a keyboard, a keypad, a button, a touch panel, a touch screen, a touch pad, a touch ball, a camera, a microphone, a gyroscope sensor, a vibration sensor and a piezoelectric element. The user interface 4500 may include user output interfaces such as a Liquid Crystal Display (LCD), an Organic Light Emitting Diode (OLED) display device, an Active Matrix OLED (AMOLED) display device, an LED, a speaker, and a monitor.

In accordance with the present disclosure, there can be provided a storage device, a host device, a user system including a storage device and a host device, and an operating method thereof, which can provide an improved security function.

While the present disclosure has been shown and described with reference to certain exemplary embodiments, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A storage device comprising:
a nonvolatile memory device including a Replay Protected Memory Block (RPMB); and
a memory controller configured to receive, from an external host, a command UFS Protocol Information Unit (UPIU) including a host RPMB message, and to store data in the RPMB according to an authentication performed using the host RPMB message,
wherein the command UPIU includes a basic header segment that is included in a UPIU exchanged between the external host and the memory controller, and
wherein the basic header segment includes a data segment length field as information indicating that the host RPMB message has been included in the command UPIU.

2. The storage device of claim 1, wherein the command UPIU further includes a transaction specific field indicating a type of the command UPIU.

3. The storage device of claim 1, wherein the command UPIU further includes a data segment including the host RPMB message.

4. The storage device of claim 1, wherein the RPMB includes:
an authentication key storage configured to store an authentication key used for the authentication;
a write counter configured to store a write count value indicating a number of times an authenticated data write operation is successfully performed in the RPMB;
a result register configured to store a result of performing an operation on the RPMB; and
an RPMB data area configured to store write data received from the external host.

5. The storage device of claim 4, wherein the memory controller includes:
an authentication manager configured to perform the authentication and output a result of the authentication; and
an access controller configured to control the RPMB, based on the result of the authentication, and
wherein the host RPMB message includes a host Message Authentication Code (MAC) and host meta data.

6. The storage device of claim 5, wherein the authentication manager includes:
a device MAC calculator configured to generate a device MAC, using the host meta data and the authentication key; and
an MAC comparator configured to generate a result of the authentication according to whether the host MAC and the device MAC are the same.

7. The storage device of claim 6, wherein the MAC calculator generates the device MAC, using the host meta data, the authentication key, and a security hash algorithm-256 (SHA-256).

8. The storage device of claim 6, wherein, when the host MAC and the device MAC are the same, the access controller controls the nonvolatile memory device to store the write data in the RPMB.

9. The storage device of claim 8, wherein the access controller stores an increased write count value obtained by increasing the write count value in the write counter, and controls the nonvolatile memory device to store a result code indicating that the authenticated data write operation has succeeded.

10. The storage device of claim 1, wherein the memory controller accesses the RPMB in a normal RPMB mode, an advanced RPMB mode, or a high speed RPMB mode.

11. The storage device of claim 10, wherein the high speed RPMB mode uses a smaller number of UPIUs as compared with the advanced RPMB mode.

12. A storage device comprising:
a nonvolatile memory device including a Replay Protected Memory Block (RPMB); and
a memory controller configured to receive, from an external host, a command UFS Protocol Information Unit (UPIU) including a host RPMB message, and to read data stored in the RPMB,
wherein the command UPIU includes a basic header segment included in UPIUs exchanged between the external host and the memory controller, and
wherein the basic header segment includes a data segment length field with information indicating that the host RPMB message has been included in the command UPIU.

13. The storage device of claim 12, wherein the command UPIU further includes a transaction specific field indicating a type of the command UPIU.

14. The storage device of claim 12, wherein the basic header segment further includes a data segment length field having a non-zero value.

15. The storage device of claim 12, wherein the host RPMB message includes an address of data to be read from the RPMB.

16. The storage device of claim 12, wherein the RPMB includes:
an authentication key storage configured to store an authentication key used to generate a device Message Authentication Code (MAC); and
an RPMB data area configured to store data.

17. The storage device of claim 16, wherein the memory controller includes:
an authentication manager configured to generate the device MAC to be used for the external host to authenticate data read from the RPMB; and
an access controller configured to generate a response UPIU as a response to the command UPIU, and provide the read data to the external host and the response UPIU to the external host.

18. The storage device of claim 17, wherein the access controller includes:
a device meta data generator configured to generate device meta data including a portion of data included in the host RPMB message; and
a device UPIU generator configured to generate a device RPMB message including the device meta data and the device MAC.

19. The storage device of claim 12, wherein the memory controller accesses the RPMB in a normal RPMB mode, an advanced RPMB mode, or a high speed RPMB mode.

20. The storage device of claim 19, wherein the high speed RPMB mode uses a smaller number of UPIUs as compared with the advanced RPMB mode.
